(19) United States
(12) Patent Application Publication
(10) Pub. No.: US 2013/0085688 A1
(43) Pub. Date: Apr. 4, 2013

(54) WATER FLOW SENSOR AND MONITORING SYSTEM COMPRISING A WATER FLOW SENSOR

(71) Applicants: CRAIG MILLER, PITTSBURGH, PA (US); MICHAEL STURDEVANT, CONCORD TOWNSHIP, OH (US); WILLIAM KAIGLER, WEXFORD, PA (US)

(72) Inventors: CRAIG MILLER, PITTSBURGH, PA (US); MICHAEL STURDEVANT, CONCORD TOWNSHIP, OH (US); WILLIAM KAIGLER, WEXFORD, PA (US)

(21) Appl. No.: 13/631,964

(22) Filed: Sep. 29, 2012

Related U.S. Application Data
(60) Provisional application No. 61/541,444, filed on Sep. 30, 2011.
(60) Provisional application No. 61/662,625, filed on Jun. 21, 2012.

(51) Int. Cl. G01F 1/66; G06F 19/00

(52) U.S. Cl. 702/48

(57) ABSTRACT

A sensor system to monitor water usage in a conduit system includes at least one acoustic sensor adapted to be placed in operative connection with a conduit of the conduit system, a power supply, a processor system in communicative connection with the acoustic sensor, and a communication system in communicative connection with the processor system. The sensor system is adapted to determine from output from the acoustic sensor at least start of flow and cessation of flow in the conduit system.

### CROSS-REFERENCE TO RELATED APPLICATIONS

This application claims benefit of U.S. Provisional Patent Application Ser. No. 61/541,444, filed Sep. 30, 2011, U.S. Provisional Patent Application Ser. No. 61/662,625, filed Jun. 21, 2012, the disclosures of which are incorporated herein by reference.

### BACKGROUND

The following information is provided to assist the reader to understand the technologies disclosed below and the environment in which such technologies will typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

A number of systems are available to monitor the wellbeing of a person. For example, currently available personal emergency response systems (PERS) provide a wearable communicator actuatable by the user in the case of an emergency. Various clinical monitoring systems can, for example, be used to monitor physiological parameters, such as blood pressure, blood glucose levels, weight, etc. A number of home or office remote monitoring systems are based upon security technology. Many currently available remote monitoring systems and/or methods for monitoring the wellbeing of a person are expensive, difficult to implement, and usually are reactive to changes in the person's condition. As a result, remote caregivers are typically alerted of a problem with the person only in the event of an acute attack or when the person initiates an alert, typically by pressing a button. Moreover, a number of sensors available for use in such monitoring system are not well-suited for the purpose.

### SUMMARY

In one aspect, a sensor system to monitor water usage in a conduit system includes at least one acoustic sensor adapted to be placed in operative connection with the conduit system (for example, with a conduit or other mechanical linkage of the conduit system through which mechanical waves are propagates as a result of flow through the conduit system), a power supply, a processor system in communicative connection with the acoustic sensor, and a communication system in communicative connection with the processor system. The sensor system is adapted to determine from output from the acoustic sensor at least start of flow and cessation of flow in the conduit system. As used herein, the term “acoustic sensor” refers to sensor that are adapted to sense mechanical waves/acoustic signals in, for example, the conduit system. Such mechanical waves include vibration, sound (within the range of human hearing, and typically between approximately 20 Hertz and 20 kilohertz), ultrasound (above the limit of human hearing and typically above approximately 20 kilohertz) and/or infrasound (below a frequency lower than 20 Hertz).

The sensor system may, for example, determine a time associated with the start of flow, a time associated with the cessation of flow and an associated duration of flow. The sensor system may further measures ambient acoustic signals (for example, mechanical waves/acoustic signals traveling through the ambient air). In a number of embodiments, the acoustic sensor is a multichannel acoustic sensor wherein one channel (of the multichannel acoustic sensor) is adapted to measure acoustic signals from the conduit system and another channel is adapted to measure ambient acoustic signals (for example, sound).

The sensor system may, for example, be adapted to analyze output from the acoustic sensor to determine if an acoustic signal is associated flow through the conduit system. The sensor system may, for example, be adapted to analyze at least one of amplitude, frequency, periodicity, timing, a time-domain signature, or a frequency domain signature to determine if the acoustic signal is associated flow through the conduit system. The sensor system may, for example, also be adapted to analyze output from the acoustic sensor to determine an associated cause of flow. The sensor system may, for example, be adapted to analyze at least one of amplitude, frequency, periodicity, timing, a time-domain signature, or a frequency domain signature to determine an associated cause of flow.

The power supply may, for example, include at least one battery. The acoustic sensor may be powered to monitor acoustic signals from the conduit system continuously, and at least one other component of the sensor system is powered off until a predetermined condition is met. The sensor system may further include circuitry in connection with the acoustic sensor to determine if the predetermined condition is met.

In a number of embodiments, the power supply comprises at least one battery, the acoustic sensor is powered to monitor acoustic signals from the conduit continuously, and at least one other component of the sensor system is powered off until output from the acoustic sensor is determined to be associated with flow. The sensor system may further include circuitry in connection with the acoustic sensor to determine if output from the acoustic sensor is associated with flow. The circuitry may, for example, include a filters such as a bandpass filter. The processor system may, for example, be powered off until output from the acoustic sensor is determined to be associated with flow. The processor system may, for example, be adapted to power off after being powered on when output from the acoustic sensor is determined to be associated with flow.

The communication system of the sensor system may, for example, include a wireless transceiver. The sensor system may, for example, be adapted to transmit data via the communication system at scheduled intervals of time. The sensor system may, for example, be adapted to determine if a predetermined threshold condition is met and to transmit data of the threshold condition prior to a next scheduled time for data transmission. The threshold condition may, for example, be a predefined duration of flow in the conduit system.

Acoustic/mechanical vibrational signals can be received from any place in the water conduit system that is mechanically linked (via piping, connectors, tanks, etc.) to the location or point at which sensor system 700 is positioned in operative connection with the conduit system. The output from the acoustic sensor may, for example, arise from flow either downstream or upstream in the conduit system from the position at which the sensor placed in operative connection with the conduit or in a parallel branch of the conduit system via the mechanical linkages of the conduit system.

In another aspect, a system for monitoring wellness of a person includes a local system in the vicinity of the person. The locals system includes a plurality of sensor systems. Each of the plurality of sensor systems is associated with at least one monitored system to monitor changes in state of the monitored systems caused by activity or lack of activity of the person. At least one of the plurality of sensor systems is a water usage sensor system including an acoustic sensor adapted to be placed in operative connection with a conduit of a conduit system, a processor system in communicative connection with the acoustic sensor and a communication in communicative connection with the processor system. The water usage sensor system is adapted to determine at least a start of flow and an end of flow in the conduit system. The system further includes a local data communication device in communicative connection with each of the plurality of sensor system to receive data from each of the plurality of sensor systems.

The system may, for example, further include a remote system in communication with the local data communication device. The remote system includes a processing system to process data from the plurality of sensor system based upon predetermined rules.

The local data communication device may, for example, be programmed to transmit data to the remote system in batches separated by intervals of time. The data transmitted to the remote system may include information on state history of the monitored systems since a previous data transmission to the remote system.

In a further aspect, a method of sensing water usage includes providing at least one acoustic sensor in operative connection with a conduit system, providing a processor system in communicative connection with the acoustic sensor, and determining from output from the acoustic sensor, at least start of flow and cessation of flow in the conduit system. The sensed water usage may, for example, be associated with wellness of a person. The sensed water usage may, for example, be associated with unauthorized presence within a space and/or a security breach. The sensed water usage may also, for example, be associated with a fault or unusual water usage (for example, a leak, unusual water usage (e.g., water left running/excessive water usage or insufficient water usage), improper refilling of commodes etc.). In a number of embodiments, the method further includes analyzing at least one of amplitude, frequency, periodicity, timing, a time-domain signature, or a frequency domain signature to determine an associated cause of flow.

In still a further aspect, t a monitoring system hereof includes a water usage sensor system as described above.

The present devices, systems and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic representation an embodiment of a system for collecting data from a plurality of devices for remote wellness monitoring.

FIG. 1B illustrates another schematic representation of the system of FIG. 1A.

FIG. 1C illustrates a another schematic representation of the system of FIG. 1A.

FIG. 2A illustrates a side view an embodiment of an energy sensor system or energy sensor for connection to an electrical outlet and to an electrically powered device or system to be monitored, wherein the energy sensor system is removed from connection with the electrical outlet.

FIG. 2B illustrates the energy sensor system of FIG. 2A in connection with the electrical outlet and a plug of a device to be monitored in alignment for electrical connection to an outlet of the energy sensor system.

FIG. 2C illustrates a schematic diagram of the components of the energy sensor system of FIG. 2A.

FIG. 2D illustrates a circuit diagram of the energy sensor system of FIG. 2A.

FIG. 2E illustrates a flowchart for the operation of an embodiment of an energy sensor system such as the energy sensor system of FIG. 2A.

FIG. 3A illustrates a schematic illustration of an embodiment of a sensor system to determine fluid flow such as fluid flow associated with water usage.

FIG. 3B illustrates a rearward side of an embodiment of a housing for the sensor system of FIG. 3A.

FIG. 3C illustrates a flowchart of an embodiment of a methodology for sensor operation wherein a processor or processor system of the sensor system is powered upon a predetermined condition associated with flow.

FIG. 3D illustrates a flowchart of an embodiment of a methodology for sensor system operation wherein the processor or processor system of the sensor system is powered off after performing signal processing.

FIG. 3E illustrates a flowchart of an embodiment of a methodology for sensor system operation wherein the processor or processor system of the sensor system initiates scheduled communication of data via the communication system at defined time intervals.

FIG. 3F illustrates a flowchart of an embodiment of a methodology for sensor system operation wherein the processor or processor system of the sensor system is adapted to initiate an unscheduled (for example, immediate) communication of data via a communication system of the sensor system upon determination of a threshold condition defined by flow of a defined duration.

FIG. 3G illustrates a circuit diagram of one embodiment of the sensor system of FIG. 3A.

FIG. 3H illustrates analog data from an embodiment of a sensor system hereof, wherein an acoustic sensor includes multiple channels, wherein a first channel measures acoustic signals from a conduit and a second channel measures ambient acoustic signals, and several spectral studies of portions of a signal from the first channel.

FIG. 3I illustrates analog data from the sensor system of FIG. 3H and a spectral study of a portion of a signal from the first channel.

FIG. 4A illustrates an embodiment of a screen for login and for device rule settings.

FIG. 4B illustrates an embodiment of a screen summarizing set rules for alerts and an embodiment of a screen summarizing resident information.

FIG. 4C illustrates an embodiment of a screen summarizing caregiver information.

FIG. 4D illustrates an embodiment of a screen setting forth an activity summary derived from state-based sensor data.

FIG. 4E illustrates an embodiment of a screen setting forth entertainment activity derived from state-based sensor data.

FIG. 4F illustrates an embodiment of a screen setting forth activity derived from state-based kitchen device sensor data.

FIG. 4G illustrates an embodiment of a screen setting forth sleep activity derived from state-based sensor data.

FIG. 4H illustrates an embodiment of a screen setting forth water use derived from state-based sensor data.

FIG. 5 illustrates a flowchart for an embodiment of methodology for the uploading of data to the remote system, the determination of associated or relevant rules, and the application of such rule to determine whether an alert should be generated.

FIG. 6 illustrates a flowchart for an embodiment of methodology for alerting one or more caregivers via one or more communication devices or systems and including an optional attempt to confirm a monitored person is OK via an attempt to communicate with or contact the monitored person.

### DETAILED DESCRIPTION

As used herein and in the appended claims, the singular forms “a,” “an”, and “the” include plural references unless the content clearly dictates otherwise. Thus, for example, reference to “a sensor” includes a plurality of such sensors and equivalents thereof known to those skilled in the art, and so forth, and reference to “the sensor” is a reference to one or more such sensors and equivalents thereof known to those skilled in the art, and so forth.

In a number or representative embodiments, a remote wellness monitoring system monitors basic day-to-day activities or lack of activity of person 5, such as sleeping behavior, television usage, eating habits, water consumption, etc. An example of such a system is described in U.S. Patent Application Publication No. 2012/0056746, the disclosure of which is incorporated herein by reference. The system provides real time monitoring of parameters indicative of the overall wellbeing of the resident and provides timely alerts designed, for example, to help prevent an acute episode. The system may, for example, be used in conjunction with a personal emergency response system (PERS) or as a standalone system, to provide relatively comprehensive remote monitoring for a remote caregiver at a price and ease of installation that is currently not available.

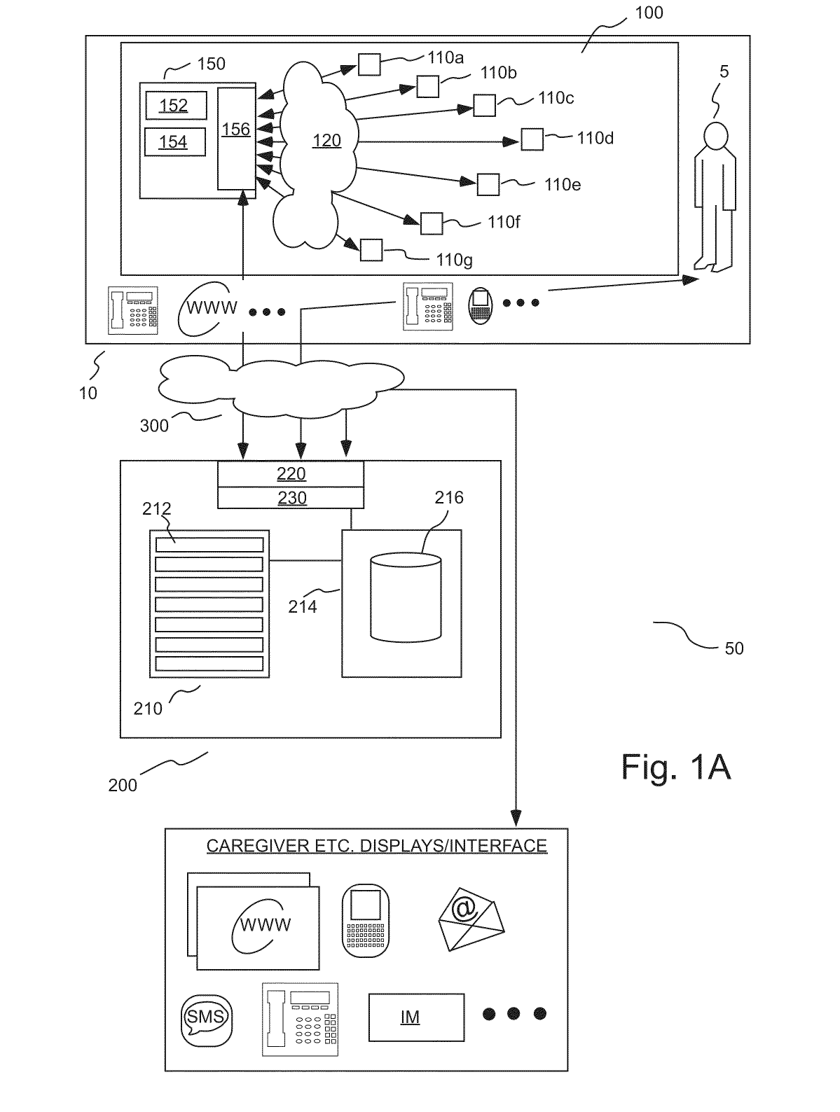

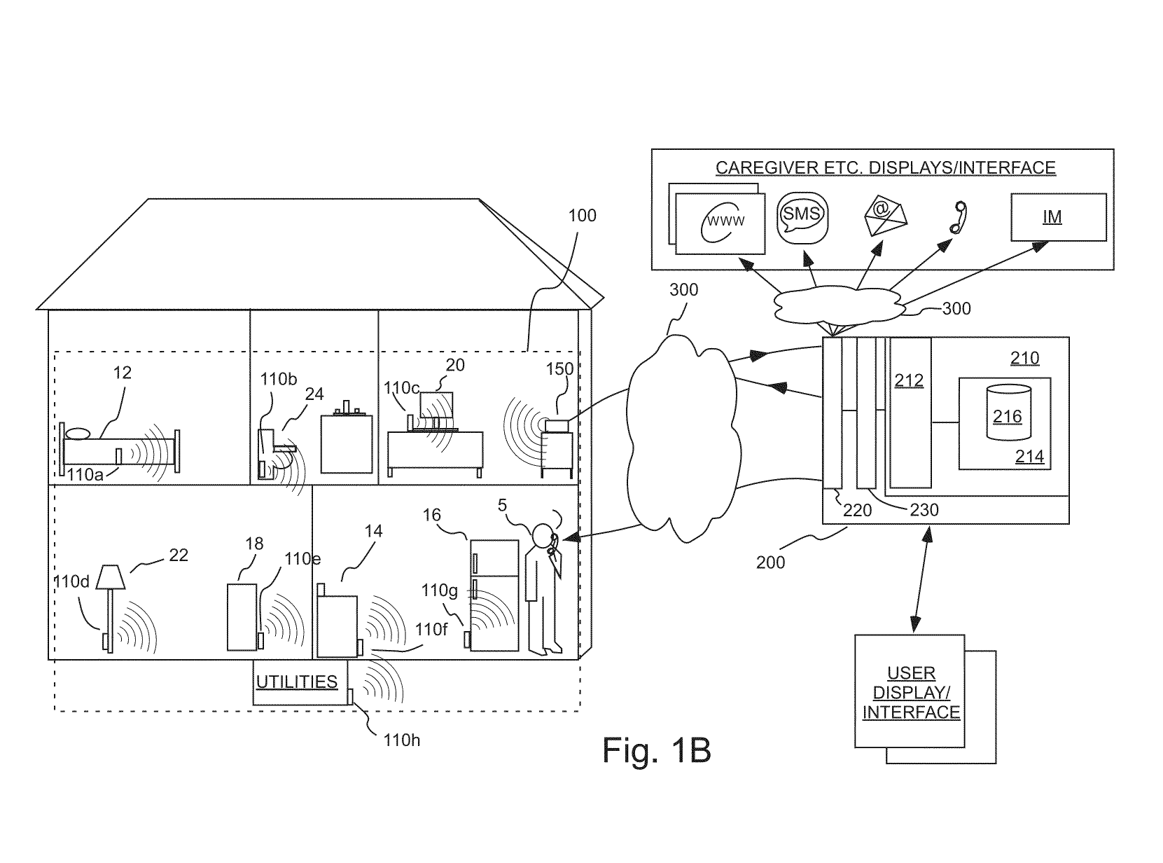

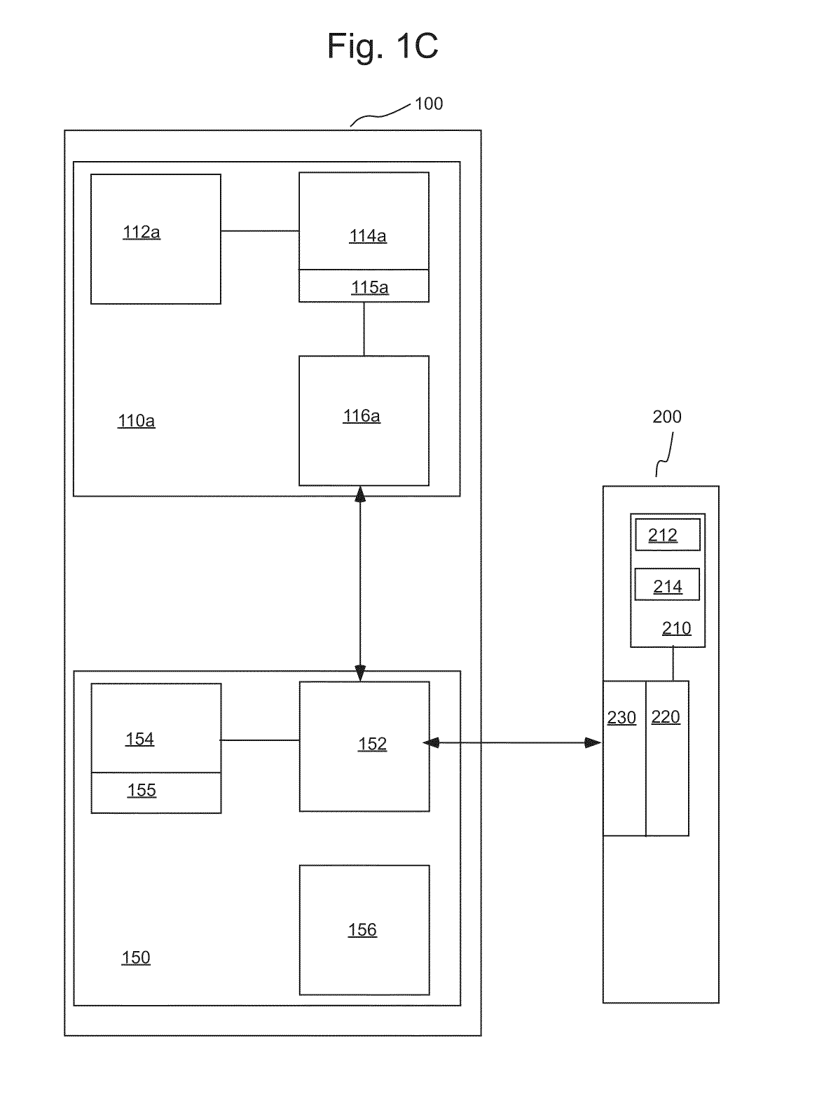

As described further below, while the monitoring of various devices and system in the vicinity of person 5 via a local system 100 (see FIGS. 1A through 1C) is real-time, the transmission of the collected data to a remote system 200, and ultimately to a caregiver (for example, a relative, friend, professional caregiver etc.), may be performed in a discontinuous or batch manner. For example, data of information of and/or a summary of the activity of person 5 for a given period (for example, a prior period of time of 24 hours) can be transmitted by local system 100 to remote system 200 for processing and/or analysis by remote system 200. Remote system 200 can received data from many local systems 100 regarding many different monitored persons 5. Local system 100 may, however, include a processing system including one or more processors programmed or adapted to determine if an emergency or exception event has occurred (based upon data from monitored devices and/or systems) which requires an expedited or unscheduled (for example, immediate) transmission or upload of data or information to remote system 200. Unscheduled uploads resulting from a determined emergency or exception event are sometimes referred herein as a transmission or upload on exception. A determination as to whether to transmit or upload on exception is made by the processing system(s) of local system based upon preprogrammed rules or protocols. Upon transmission of data to remote system 200, a processing system of remote system 200 may make further determinations, and may, for example, notify a caregiver of the exception.

Depending upon the bandwidth of communication channels between local system 100 and remote system 200, the frequency of uploading collected data to remote system 200 may be increased. Moreover, upon occurrence of certain events such as emergency or exception events, certain data may be uploaded in continuous or substantially continuous manner (for example, in real time). Furthermore, in the case of certain sensor systems (for example, sensor systems to monitor physiological parameters) for certain persons, it may be desirable to increase the frequency of uploads to remote system 200 or to transmit real time data in a continuous or substantially continuous manner in real time to remote system 200 even absent an exception event.

In a number of representative embodiments (as illustrated, for example, in FIGS. 1A through 1C), local system 100 of a monitoring system 50 hereof includes a plurality of sensor systems 110a, 110b, 110c, 110d, 110e, 110f, 110g etc. which communicate using a local network 120 such as a wireless local area network (LAN) with a local data communication device or hub 150. Local system 100 may, for example, be used in connection with a residence, a household, a abode or (generally) a space 10 in the vicinity of person or persons 5. In that regard, plurality of sensor systems 110a, 110b, 110c, 110d, 110e, 110f, 110g etc. may, for example, be operatively connected to or associated with furniture, utilities, equipment, devices, systems or appliances, such as one or more beds 12, ranges 14, refrigerators 16, televisions 18, computers 20, lamps/lights 22 toilets 24, a water utility inlet pipe etc. (see, for example, FIG. 1B). Data from sensor systems 110a, 110b, 110c, 110d, 110e, 110f, 110g etc. of local system 100 (which may be processed at least to some extent in local system 100) may be communicated, transmitted, or uploaded to remote system 200 via, for example, local data communication device 150. Remote system 200 may, for example, include a central processing system or a distributed processing system that may, for example, include one or more computers, servers or server systems 210. Computer(s), server(s) or server system(s) 210 may, for example, include one or more processors or processor systems 212 which are in communicative connection with one or more memory or storage systems 214 as known in the computer arts. Memory system(s) 214 may include one or more databases 216 stored therein. Local system 100 may communicate with a communication system or systems 220 of remote system 200 (for example, via local data communication device 150) through one or more wired or wireless communication channels 300 (for example, landline telephones, wireless telephones, a broadband internet connection and/or other communication channel(s)). Software stored in memory system(s) 214 or in one or more other memory system in communicative connection with processor(s) 210 may be used to process or analyze data from local system 100 and, for example, assist a caregiver with a long-term care plans, alerts, use of additional sensor systems etc.

In a number of embodiments, communication system 220 is in communicative connection with a gateway processor 230 of remote system 200. Gateway processor 230 may, for example, receive data from local data communication device 150 of local system 100, process that data (which may, for example, be received in binary file format) into a format readable by software executed by processor 210, and insert the processed data into database 216. In a number of embodiments, gateway processor 230 is adapted to receive data of a number of different types (for example, data regarding states from sensor systems 110a, 110b, 110c, 110d, 110e, 110f, 110g, data regarding medical device usage, etc.), provide initial processing of such data and route such data into a designated system such as into database 216.

Processing system(s) or server system(s) 210 of remote system 200 receive data from local system 100 and, for example, use/processes the data to implement a long-term care plan. Server system(s) 210 can, for example, apply predetermined rules and/or logic defining alert thresholds, alert methods, appointed caregivers, associated reports for trending etc. in implementing a care plan. Remote alerts can, for example, be activated in the case of predetermined events (or a series or groups of events) or at predetermined levels (as determined by monitoring system 50 on the basis of established rules and/or protocols) so that caregivers can respond in a proactive manner to changes in behavior and/or status of person 5. The alerts can, for example, be dispatched or made available to one or more caregiver (or others) via displays or interfaces in any number of ways through communications channel(s) 300 including, but not limited to interactive voice response or IVR, short message service or SMS, internet web pages, email, other internet communications (for example, instant messaging or IM), and/or smart phone/client applications. Compared to currently available monitoring systems, monitoring systems 50 hereof provide more proactive/timely alerts, while significantly reducing cost and complexity of installation. Caregivers can also transmit inquiries to remote system 200 via one or more communication channels 300 as described above to, for example, inquire of the current “status” of person 5. Such an inquiry may, for example, result in a polling of sensor systems 110a, 110b, 110c, 110d, 110e, 110f, 110g etc. by local data communication device 150 for current or most recent data, which is the uploaded to remote system 200. Further, system 50 can transfer information to third parties (for example, physicians etc.) on the instructions of person 5 as part of an overall care plan. For example, a physician (or other authorized third party) portal can be provided as a module of communication system 220 of remote system 200.

As discussed above, sensor systems 110a, 110b, 110c, 110d, 110e, 110f, 110g etc. of local system 100 may, for example, be used in connection with person(s) 5, space 10, a variety of medical devices, appliances, equipment, utilities etc. to monitor the person's wellbeing by, for example, monitoring activity/inactivity of person 5. Table 1 provides a non-exhaustive listing of a number of representative devices and/or systems that may be monitored and representative sensor types for use in monitoring such devices and/or systems. Information or data can also be garnered from systems external to local system 100 or to space 10. For example, temperature data, weather data etc. can be measured or downloaded from various sources available on networked (for example, via the internet) databases.

TABLE 1

| Device or System Monitored | Representative Sensor Types |
|---|---|
| Medical Devices | Various sensors appropriate to |
| | device technology |
| Appliance/Device Current | |
| (10 mA-15 A range) | |
| Appliances (TV) | Current Sensing |
| Appliances (Radio) | Current Sensing |
| Appliances (Computer) | Current Sensing |
| Appliances (Fan, Room AC) | Current Sensing |
| Appliances (Heater, | Current Sensing |
| El Blanket) | |
| Appliances (Elec. Toothbrush) | Current Sensing |
| Appliances (Hair Dryer) | Current Sensing |
| Appliances (other) | Current Sensing |
| Appliances (Refrigerator | Ambient Light Sensing, temperature, |
| door open) | current - run-time vs. room temperature |
| | (RF inside metal box) |
| Bed Sensor | Pressure Switch |
| | Accelerometer |
| | Passive IR |
| | Pressurized bladder/Hot Water Bottle |
| | Moisture/Humidity/Wetness |
| Occupancy (Area/Room) | Passive IR |
| | Ambient Light |
| | Acoustic |
| | Microwave |
| | Ultrasonic |
| Kitchen - Oven | IR thermometer |
| | Thermocouple |
| | Current or gas supply |
| | Microwave radiation sensing (2.4 GHz) |
| Kitchen - other | Current sensing (microwave, Fridge, |
| | toaster, coffee maker, other electrical) |
| Phone usage/problem | Off-hook monitor - time delay and |
| | general usage profiling |
| Water (Flow) | Pipe Temperature (absolute & |
| | vs. ambient) |
| | Acoustic sensor |
| | Water Level (float in tank) |
| | Ultrasonic flowmeter |
| | Positive displacement flowmeter |
| Water Leakage | Conductivity (water/other liquid on floor) |
| Water Temperature | Thermistor/Silicon, IR, thermocouple, |
| | thermostat |
| | Freeze & scald protection |
| Temperature (room/area) | Local to most/all sensors - |
| | inexpensive to implement, |
| | diagnostics, implicit trending, |
| | correlate with local outside |
| | temperature to assess HVAC |
| | operational status |
| Temperature (outdoor) | Temperature sensors - |
| | Information from other external |
| | systems such as web temperature info |
| Doorbell | Acoustic, current |
| Intrusion, Glass Breakage | Acoustic, ultrasonic, microwave |
| Shower | Humidity (delta), optical |
| 230 V systems, | Amp clamp or similar isolated current |
| high-current systems | sensing (DW, dryer, furnace, A/C) |
| Garage door open | Tilt |
| | Ambient Light Sensing |
| Universal interface (I/O - | ex: door open switches, alarm systems, |
| other systems) | HVAC controls, doorbell, |
| | 3rd party sensors |
| CO Alarm/Natural | Electrochemical etc. |
| Gas Alarm | Sn-oxide |
| Shock (bottom of steps, | Accelerometer acoustic |
| other likely fall locations) | |
| Walker issues | Tilt |
| | Accelerometer |

As illustrated for representative sensor system 110a in FIG. 1C, sensor systems hereof may include at least one sensing or measuring system 112a, at least one processing system or processor 114a (for example, a microprocessor), at least one a memory system 115a and at least one communication system 116a. Sensor system 112a is adapted or operable to measure one or more variables associated with, for example, a state or change in state of a monitored system. Such states are predefined states or conditions which are dependent upon a system being monitored. Data measured and communicated to local data communication device 150 may, for example, include a time of onset of a state (that is, a time of change from a previous or first state to a latter or second state) and data related to the duration of the state (for example, a time of cessation of a state and/or duration of the state). Processor 114a may, for example, perform operations on data received from sensing system 112a, in a manner predetermined by programming therefor which may be stored in memory system 115a. Processor 114a communicates information or data to communication system 116a, which is adapted or operable to transmit the information or data to, for example, local data communication device 150.

Local data communication device 150 includes at least one communication system 152 which communicates (either unidirectionally or bidirectionally) with communication system 116a of sensor system 110a. In a number of embodiments, each of sensor communication system 116a and communication system 152 includes a wireless transceiver for wireless communication (for example, using a ZIGBEE® or other wireless communication protocol). In the illustrated embodiment, local data communication device 150 further includes one or more processors 154 and one or more memory systems 155. Processor 154 may, for example, be programmed or adapted (via programming stored in memory system 155) to process (or to further process) data from sensor systems 110a, 110b, 110c, 110d, 110e, 110f, 110g etc. Processor 154 may further be programmed or adapted to initiate signals to be transmitted to sensor systems 110a, 110b, 110c, 110d, 110e, 110f, 110g etc. such as wake up signals, data polling signals etc. Moreover, processor 154 may further be programmed or adapted to control communications between one or more communication modules of communication system 152 and one or more modules of communication system 220 of remote system 200. Although a separate local data communication device 150 is provided in a number of embodiments hereof, the functionality of local data communication device 150 can be performed, in whole or in part, by one or more of sensor systems 110a, 110b, 110c, 110d, 110e, 110f, 110g etc.

In a number of currently available monitoring system for various uses, one or more monitoring devices stream analog-based data to a remote or central server or software device which then converts the streamed data to meaningful information. Analog data is by its nature memory intensive and network bandwidth intensive, thereby increasing the cost of transmitting the data, slowing the transmission of the data, and limiting/consuming network bandwidth.

In several embodiments of the methods and systems hereof, plurality of sensors 10a, 10b, 10c, 10d, 10e, 10f, 10g, etc. as described above monitor a set of variables or parameters indicating state(s), changes in state and/or a lack of a change in state (for example, indicating operational use or disuse) of, for example, household devices or systems, household appliances, utilities (for example, water, electricity, sewage, gas, fuel oil etc.), furniture (or example, beds, chairs etc.) medical devices and/or any other devices or systems. Sensors 10a, 10b, 10c, 10d, 10e, 10f, 10g, etc. collect analog data which are recorded (or convert into) event or state-based data, which can be represented as discrete values. Data of states and changes of states (as defined in monitoring system 50) of a monitored device or system may, for example, be generated to provide a state history in which, for example, defined states and durations of such defined states over time are set forth for a period of time. Rather than transmitting a stream of analog operational or status data, state-based data or values which, for example, correspond to the state or state history of a monitored device or system (for example, time of use/state change, duration of state, level of use etc.) for a period of time are transmitted in a noncontinuous, discontinuous or batch manner at intervals spaced in time (although not necessarily at regularly spaced intervals) to communication system 20 of remote system 200. In that regard, the data may be transmitted by communication system 152 of local data communication device 150 via one or more of communication channels 300 (for example, via telephone, internet etc.) to communication system 220 of remote system 200. The data may, for example, be transferred periodically (for example, hourly, daily etc.). Different data or values may, for example, be transmitted with different time intervals or frequencies depending upon the nature of the underlying event(s) or values as set forth in predetermined rules.

As described above, some processing of data occurs in a processing system of local system 100. Such processing may, for example, occur in a processor or processors of one or more of sensors 10a, 10b, 10c, 10d, 10e, 10f, 10g, etc. (for example, in processor 114a of sensor system 110a), in a processor or processors 154 of local data communication device 150 and/or in one or more other processors of local system 100 before transfer of data to the remote system 200. In a number of embodiments, local data communication device 150 serves as a repository for all information coming from sensors 10a, 10b, 10c, 10d, 10e, 10f, 10g, etc. Additional processing in processor 154, when effected, may, for example, include: comparing of values with prior average values, evaluation of combinatorial events from more than one sensor or sensor system to infer or determine situations or events not necessarily inferable or determinable from a single sensor or sensor system, and the transmission of data/information to remote system 200. In that regard, a plurality of sensors working in concert as part of a larger network monitoring system and designed to upload data on, for example, a predetermined period leave open the possibility that a meaningful event can occur in space 10 that does not generate an alert or alerts from remote system 200 until the data is uploaded to remote system 200. This delay can reduce the effectiveness of monitoring system 50 and potentially result in negative clinical benefits to person 5 if it results in delay of an appropriate reaction to a clinical need or problem. Continuous streaming of analog data may prevent such negative clinical outcomes, however, as described above, transmission of real time streams of monitored data is expensive, requires substantial network bandwidth and requires a substantial amount of memory.

In a number of embodiments, transmission of data to remote system 200 occurs on a regular, periodic basis and/or on an unscheduled or exception basis. In that regard, exceptions or triggering events defined by predetermined states or state changes, groups of states or state changes, events, thresholds, or business logic, are established which, when determined to be in existence (using defined rules), trigger an automatic upload of data to remote system 200 regardless of predetermined upload cycles. Such exceptions or triggering events result in more timely and effective monitoring of person 5. Software or logic to determine such an exception or a triggering event can, for example, be resident on a sensor system, on local data communication device 150 and/or on a separate processor system of local system 10. Thus, an exception occurs when a condition is determined to exists (via processing/analysis of sensor data in local system 100) which requires expedited or immediate attention from remote system 200.

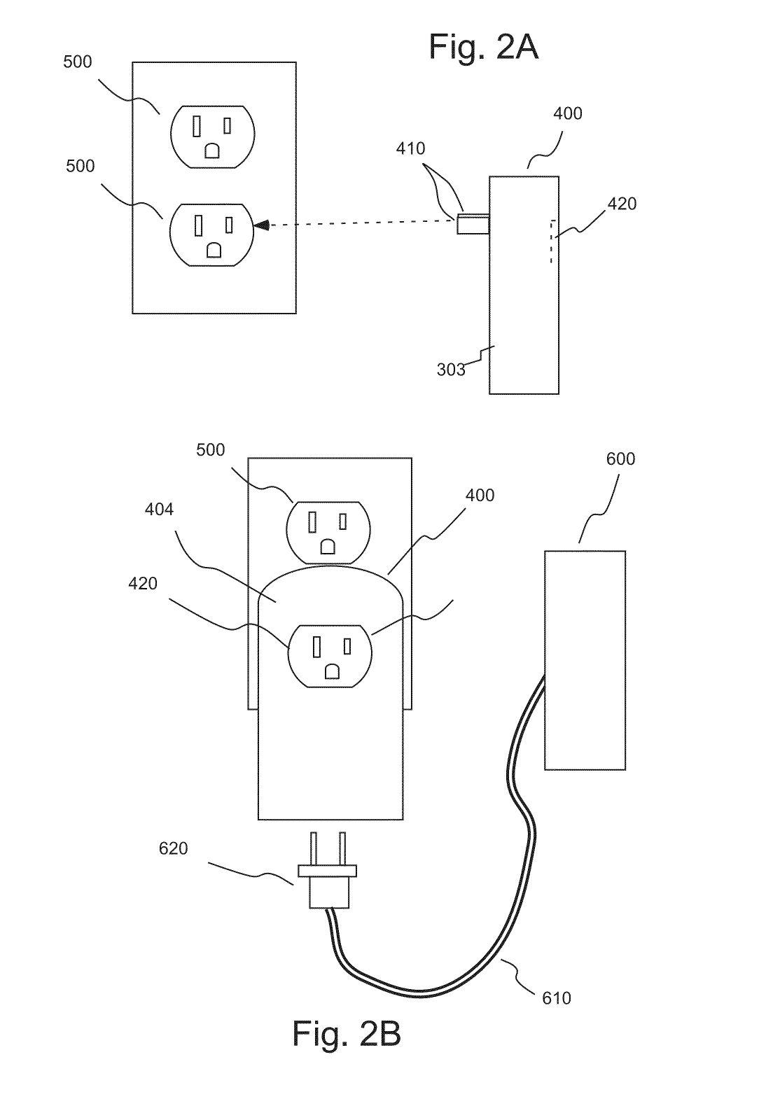

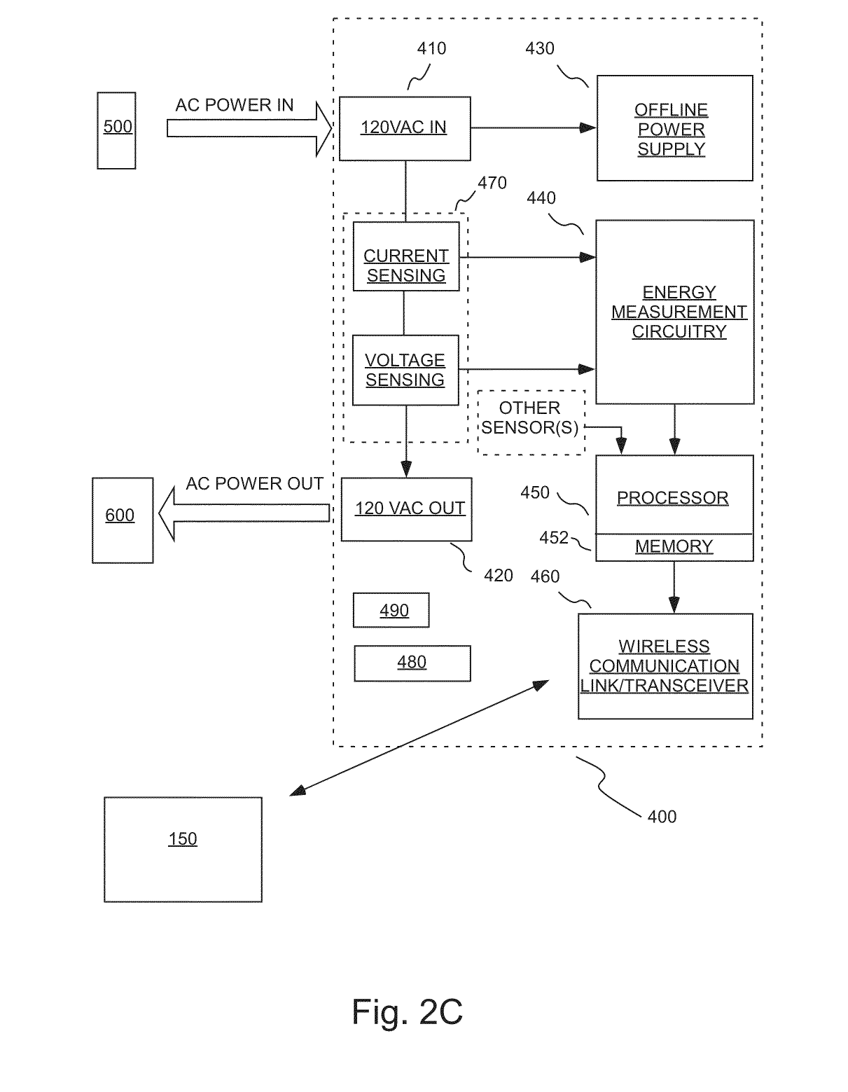

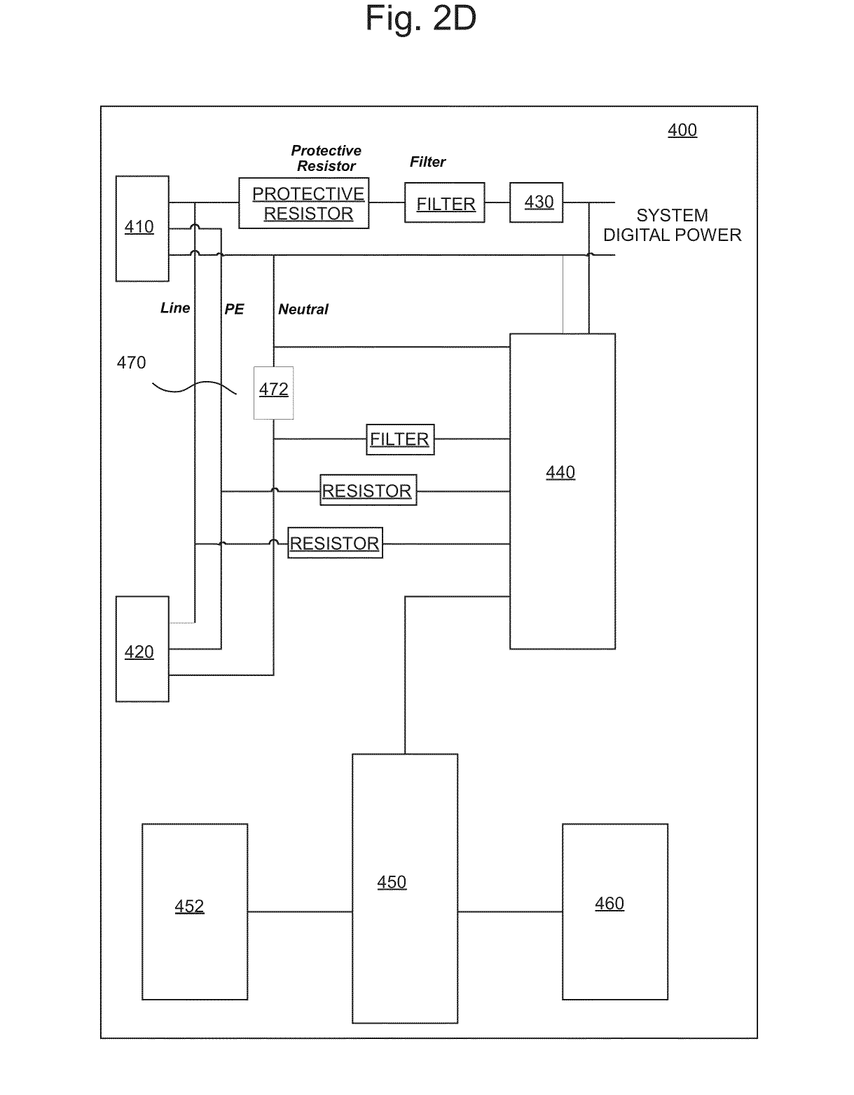

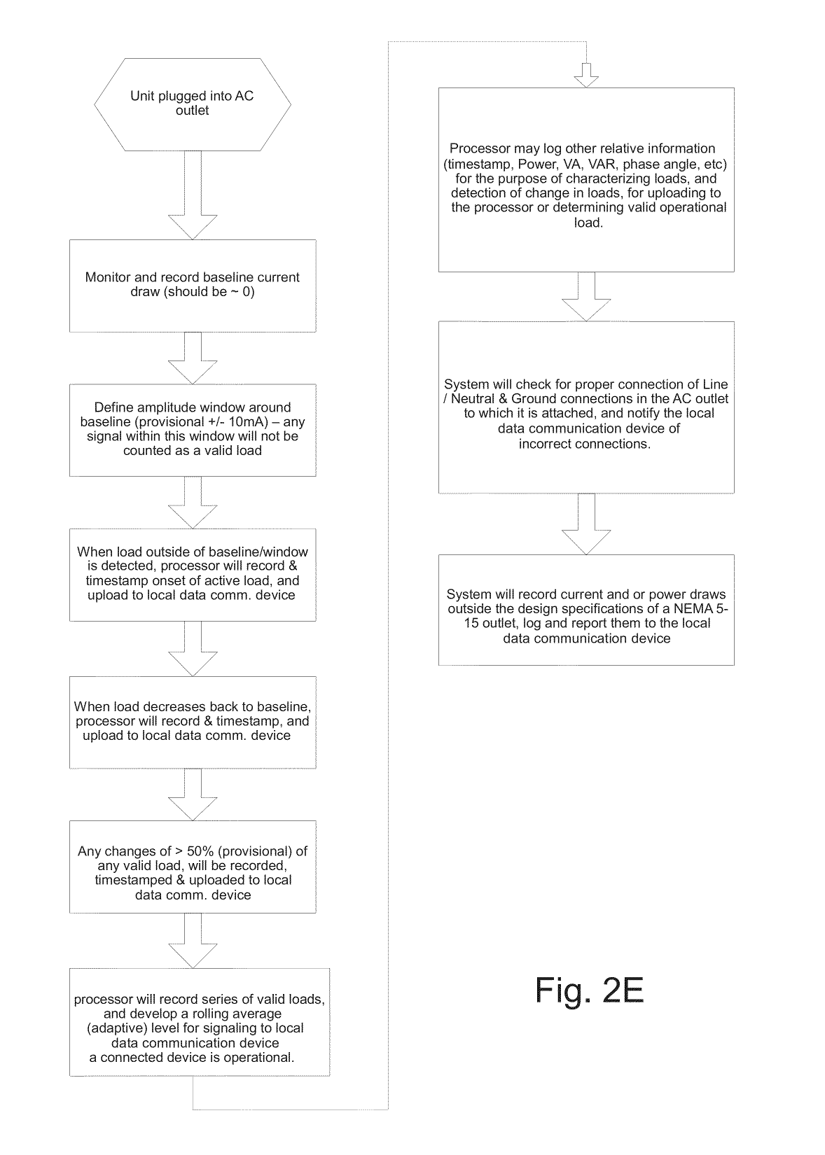

Several types of representative sensor systems for use in the systems hereof are discussed in further detail below. One type of sensor system used in the systems hereof is an energy sensor system that can be used in connection with electrically powered devices attached to an electrical outlet in space 10. One or a plurality of sensor systems 10a, 10b, 10c, 10d, 10e, 10f, 10g, etc. may be an energy sensor system as describe herein. A representative embodiment of a modular or universal energy sensor system 400 for use with electrically powered devices is, for example, illustrated in FIGS. 2A through 2D. Energy sensor system 400 can, for example, be used in connection with monitoring any one of many electrically powered devices (for example, televisions, radios, computers, kitchen appliance, other appliances etc.). For example, energy sensor system 400 can be used in connection with an device or system operating within a defined range of voltages and/or a defined range or currents. Energy sensor system 400 may, for example, be plugged into a standard NEMA wall power outlet or receptacle 500 via plug contacts 410 extending from a rearward surface of a housing 404 of energy sensor system 400. Energy sensor system 400 may also include a standard NEMA outlet 420 to receive a standard NEMA plug 620 of a power cord 610 from a monitored device 600 (see FIG. 2B), such that the current flows through the circuitry (see FIGS. 2C and 2D) of energy sensor system 400. The existence, magnitude, phase angle, voltage etc. of current draw through power cord 610 indicates, for example, that monitored device 600 is in use, the duration of use, the nature of the use etc.

Energy sensor system 400 may, for example, be standardized for universal use in connection with devices using, for example, 110 volt power. As described above, energy sensor system 400 may be plugged into any standard household AC outlet, socket or receptacle 500, and may receive standard NEMA 5-15 power plug 620 from cord 610 connected to any device 600 to be monitored. As illustrated in FIG. 2C, AC power is supplied to energy sensor system 400 via, for example, standard NEMA 5-15 power plug 410. AC power is supplied from energy sensor 400 to monitored device 600 via, for example, standard NEMA 5-15 power socket 420.

Power for the circuitry of energy sensor system 400 may, for example, be derived from an off-line switching power supply 430. Power supply 430 may, for example, include an integrated circuit, IC or chip such as a Linkswitch LNK-305 series IC available from Power Integrations of San Jose, Calif. and associated passive components, which generate a voltage of, for example, −3.3VDC with respect to an AC neutral line. In the illustrated embodiment, power supply 430 powers an energy monitoring chip 440, a computer processor 450 (for example, a microprocessor) and a wireless communication link or module 460.

A sensor 470 may, for example, include a low value (for example, 0.004Ω nominal) series ohmic shunt 472 which is placed in series with the neutral connection between NEMA input plug 410 and NEMA output socket/outlet 420, to which monitored device 600 is connected. A voltage is developed across the shunt resistor, which is proportional to the current flowing through it. The measured current may be used for the calculation of current draw, power, and/or other parameters of monitored device 600. Voltage sensing of the AC circuit being monitored may, for example, be accomplished via a network of high-value resistors which are connected to line, neutral and ground. The measured voltage may be used to determine voltage, phase angle, power factor and other parameters of interest of the power source and effects thereon by the connected load.

In a number of embodiments, a Maxim 78M6612 power and energy measurement integrated circuit, chip or system-on-a-chip available from Maxim Integrated Products, Inc. of Sunnyvale, Calif., monitored the voltage and current delivered to monitored device 600 through the above-described electrical networks, and processed the information to generate digital information including, but not limited to, AC voltage, current, power, VA, phase angle and other parameters which characterize the operational status or state of monitored device 600. Operation of the Maxim 78M6612 power and energy measurement integrated circuit is described in the 78M6612 Single-Phase, Dual-Outlet Power and Energy Measurement IC Data Sheet, Maxim Integrated Products, Inc. (June 2009), the disclosure of which is incorporated herein by reference. Processor 450 is, for example, a Microchip PIC-series PIC24FJ128GA006-I/PT microprocessor available from Microchip Technology, Inc. of Chandler, Ariz. Operation of the Microchip PIC-series PIC24FJ128GA006-I/PT microprocessor is described in the PIC24FJ128GA010 Family Data Sheet, Microchip Technology, Inc. (2009), the disclosure of which is incorporated herein by reference. Processor 450, may for example, perform operations on the electrical data received from the energy monitoring chip 440, as, for example, specified in the operational description below and the flowchart of FIG. 2E. Processor 450 relays information via, for example, wireless communication link 460 (which may, for example, be an RF connection using, for example, Zigbee protocol) to local data communication device 150. A wireless RF communication connection may, for example, be established via a Microchip MRF24J40MA-I/RM Zigbee module available from Microchip Technology, Inc., which is controlled by processor 450. Operation of the Microchip MRF24J40MA-I/RM system is described in MRF24J40MA Data Sheet, Microchip Technology, Inc. (2008), the disclosure of which is incorporated herein by reference. Communication link 460, for example, uploads the information derived from energy monitoring chip 440 under control of processor 450, in accordance with defined variable changes corresponding to defined changes of state of monitored device 600. Sensor or sensing circuitry 470, wireless communication link 460, processor 450, energy measurement circuitry 440, and power supply 430 are integrated into a single unit within housing 404.

Devices such as monitored device 600 may, for example, operate from a nominal 110 VAC source, and may, for example, be limited in current draw to approximately 15 A. In a number of embodiments, the minimum current draw which may be resolved is approximately 0.010 A. One or more indicators 480 (see FIG. 2C) such as one or more lights may be provided to indicate different operational states of energy sensor 400, including, but not limited to, communication (RF) pairing, ready for operation, power available and/or fault status. A switch 490 (see FIG. 2C) may be provided for a user to, for example, initiate an RF pairing process, wherein energy sensor 400 is associated with a specific central data collection point or local data communication device 150 operating on the same RF channel. Switch 490 may, for example, be mechanical, magnetic or operated by other inputs. Energy sensor system 400 may, for example, include one or more magnetic reed, capacitive or other switches for the purpose of performing various functions, including, but not limited to the initiation of RF pairing operations.

As set forth in the flowchart of FIG. 2E, energy sensor system 400 may, for example, monitor and record a baseline current draw (for example, approximately 0 A in a number of devices). As described above, an amplitude window around the baseline (such as approximately +/−0.010 A or 10 mA) may be defined. Any signal within the defined amplitude window will not be considered a valid load. When a load is outside of the baseline window is detected, processor 450 may, for example, record and timestamps the onset of the measured current/active load. This information may be uploaded to local data communication device 150. When the measured load decreases to the baseline load, processor 450 records and timestamps the decrease in load. This information may also be uploaded to local data communication device 150. In a number of embodiments, any changes of a certain threshold (for example, 50% or greater) of any valid load are recorded, time-stamped and uploaded to local data communication device 150. Processor 450 may, for example, record a series of valid loads and develop a rolling average (adaptive) level for signaling to local data communication device 150 that monitored device 600 or other connected device is operational. As described above, processor 450 may log other relevant information (for example, timestamp, power, VA, VAR, phase angle, etc.) to characterize loads and detection of changes in loads for uploading to local data communication device 150 and/or for determining valid operational load.

Energy sensor system 400 is adapted to or operable to monitor an unknown variety of devices which may, for example, be found in space 10 (for example, a home). Because of this uncertainty regarding the status of a device in terms of, for example, current draw during various states (for example, when “on”, “asleep”, “off” or in another mode or state), energy sensor system 400 monitors various current or power draws of the device over a predetermined period (for example, in the range of approximately 3-7 days). As energy sensor system 400 monitors the power or current draw of the connected/monitored device, it may, for example, record minima and maxima of those values. From the minima and maxima data points, a reference in between those points may be generated or determined that is set as the decision point for determining whether a device is, for example, in an “on” state, in an “off” state or in another defined state. This methodology is in contrast a methodology in which a fixed threshold is established for determining operational status or state. Many devices continue to draw current even while in an “off” state (in terms of the user's perception) and any preset or fixed threshold runs the risk of incorrectly determining the status of a connected device. Energy sensor system 400 continuously record and updates the determined threshold, making energy sensor system 400 usable even if the connected device is changed.

In a number of embodiments, after a device such as device 600 is connected to energy sensor system 400 and a nonzero load is detected, energy sensor system 400 begins recording measured current values. After a defined period (for example, 72 hours), energy sensor system 600 may, for example, determine the standard deviation of the measured values, and, if exceeding a preset or determined amount, average the group of values in the high range, and average the group of values in the low range. Energy sensor system 600 may then establish a threshold using an equation such as, for example, avg low+(avg high−avg low)/5 or a similar equation, and use the calculated threshold to determine and record states (for example, on or off states). As the values are continuously recorded, the averages and determined threshold may update, so that energy sensor system 400 dynamically adapts.

In general, energy sensor system 400 may send status of electrical power, and/or status of monitored device 600 in real-time to local data communication device 150, or timestamp and store such or similar information for transmission at a predetermined or externally requested time. With respect to the status of electrical power, energy sensor system 400 can readily detect an incipient loss of power and transmit data regarding such an event to local data communication device 150. Likewise, energy sensor system 400 can detect resumption of interrupted power and transmit such data.

Energy sensor system 400 may also check for proper connection of the line, neutral and ground connections in AC outlet 500 to which it is attached and notify local data communication device 150 or incorrect connections. Energy sensor system 400 may also record current, power draws and/or other measure variables outside the design specifications of a NEMA 5-15 (or other specified) outlet and log and report such information or data to local data communication system 150.

In the systems and methods hereof, use of a monitoring technology to track usage of a variety of household electrical items and/or appliances is simplified with the use of a universal sensor system such as energy sensor system 400. Because energy sensor system 400 may be used in connection with more than one type of device, the identification of the device being monitored may be desirable.

If the device being monitored is assigned or identified incorrectly, false positives or negatives in uploads on exception and/or alerts generated by remote system 200 may result, thereby reducing the effectiveness of monitoring system 50 in monitoring the wellbeing of person 5 Energy sensor system 400 and/or other universal sensor system may, for example, be provided with a selector via which person 5, a caregiver, an installer or other person identifies the type of device to which the sensor system is attached. However, such a selector leaves open the possibility of human error.

Processor 450 of energy sensor system 400 (and/or one or more processors in communication with energy sensor system 400) may, for example, use the existence of unique current draw and/or other characteristics to determine if energy sensor system 400 is being used in connection with a particular device or system. Processing system 450 of energy sensor system 400 may, for example, execute one or more algorithms to determines operational status of a connected device. Each monitored device or system has unique current draw and/or other electrical characteristics which may be used to either identify the device or system, or, at a minimum, rule out certain other possibilities. Examples of parameters to be monitored to determine an attached device include current frequency, current amplitude, phase angle, Fourier transform pattern, real power, reactive power, imaginary power, power factor etc. Algorithms to identify and/or monitor a device may, for example, consider sleeping modes or states, energy saving modes or states, etc. and dynamically adapt to different devices automatically. Operating and/or non-operating electrical characteristics of a monitored device or system can, for example, be compared characteristics of known electrical devices or systems for the purpose of determining or inferring the type or nature of an otherwise unknown connected device. Stored equations or look-up tables of known electrical device characteristics can, for example, be stored in memory system 452 of energy sensor system 400 or in a memory system in communicative connection with energy sensor system 400 for comparison to measured characteristics of a monitored device or system.

After determination of the type, nature or identity of a connected/monitored device, a logic check can, for example, be performed to ensure that current draw and/or other characteristics are consistent with the device assigned to a given monitor. If the current draw and/or other characteristics do not match the assigned device, the associated data can, for example, be flagged as suspect. Such a device recognition system can, for example, reduce errors and simplify installation. The logic check can, for example, using a processing system of local system 100 and/or a processing system of remote system 200 (for example, using energy sensor system 400, local data communication device 150, server system 210 and/or another processing system).

Variables other than can energy-related variables can, for example, be monitored by energy sensor system 400 via one or more other sensors (illustrated schematically in FIG. 2C). For example, energy sensor system can also include one or more other sensors to monitor environmental signals such as ambient light, motion, acoustic noise, temperature, humidity and/or other environmental conditions. Such conditions can, for example, effect current- or other energy-related variables measured by energy sensor system 400 and may, for example, be used for the evaluation of circuit performance or ambient environmental conditions and/or correction of measured energy-related variables.

In the case of devices or appliances that use current other than 110 volt current (for example, an electric range), a sensor system other than energy sensor system 400 may be used. For example, an impedance sensor system may be used to measure or determine states, changes of state etc. For example, a current sensitive/impedance sensor system can be placed in operative connection with (for example, fit around) the power cord of the electric range or other device. The existence of current draw through the power cord will, for example, indicate that the range or other device/system is in use, and for what duration.

In the case of a number of devices, changes in state secondary to the primary function of the device (for example, from one or more subsystems of the device) can be monitored to measure changes in state of the device. To monitor refrigerator usage, for example, a light-sensitive sensor system or a current- or energy-based sensor system (for example, as described above) in electrical connection with the refrigerator/refrigerator light bulb may be used to monitor state changes of the refrigerator. For example, a current sensitive sensor system may be used in connection with the electrical outlet of the refrigerator light. The existence of current draw through the refrigerator light bulb indicates that the refrigerator door has been opened, and for what duration.

Various sensor systems can also be used to measure utility usage such as water, heating and air conditioning, sewage etc. By, for example, measuring the water intake of a household (or other abode) at the input pipe of the household, a remote caregiver has the ability to track water usage associated with monitored person 5 using the bathroom, taking showers, washing dishes, washing clothes, etc. These behaviors are, in part, an indication of the wellbeing of monitored person 5.

Water consumption can, for example, be measured using a variety of methods including, for example, a mass flow sensor system that clips around the intake pipe of the household water supply and senses water flow and/or water volume consumed, a temperature sensor system that senses temperatures different than room temperature as well as other methods.

In a number of embodiments, a water usage sensor system includes an acoustic sensor operatively connected to one or more water flow conduits in space 5 to sense acoustic patterns indicative of water flow/usage. The sensor system is adapted to or operable to determine whether a measured signal is a valid signal (that is, a signal actually associated with water flow through or from a conduit or stray acoustic signals/sound conducted through the conduit).

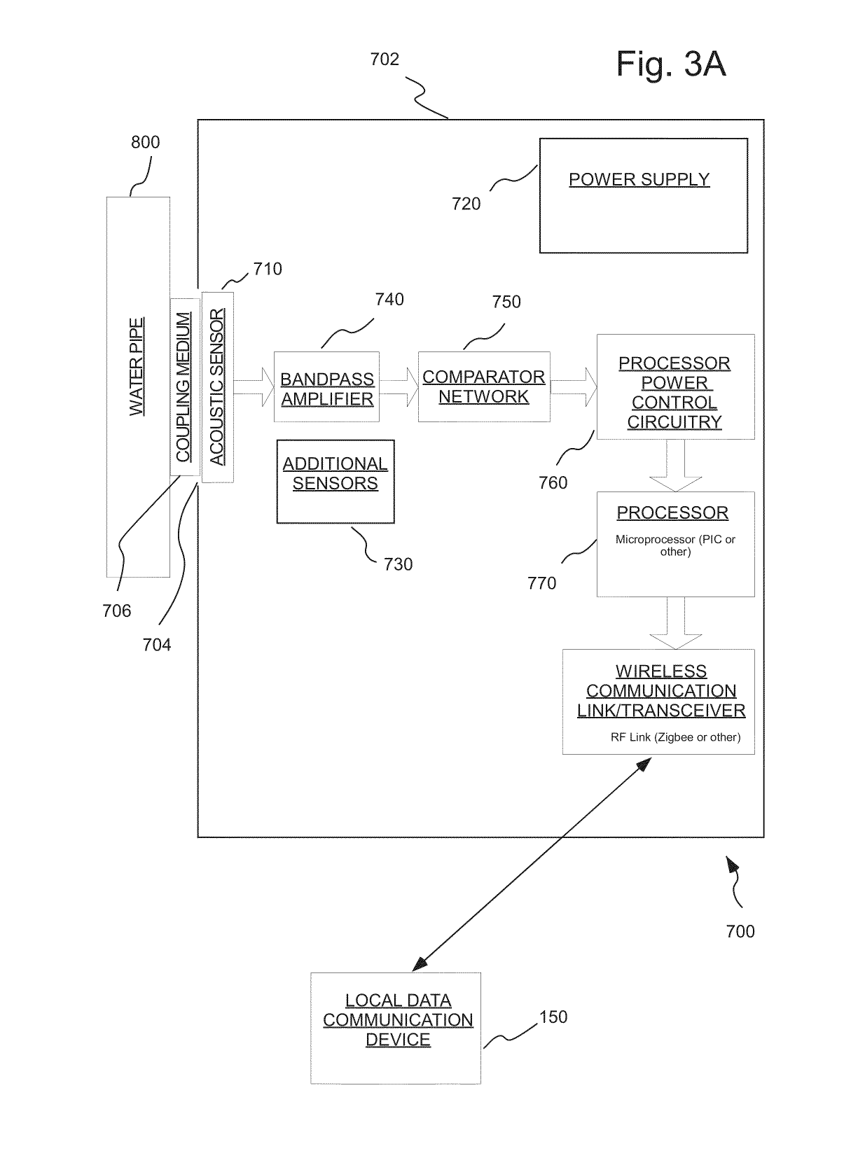

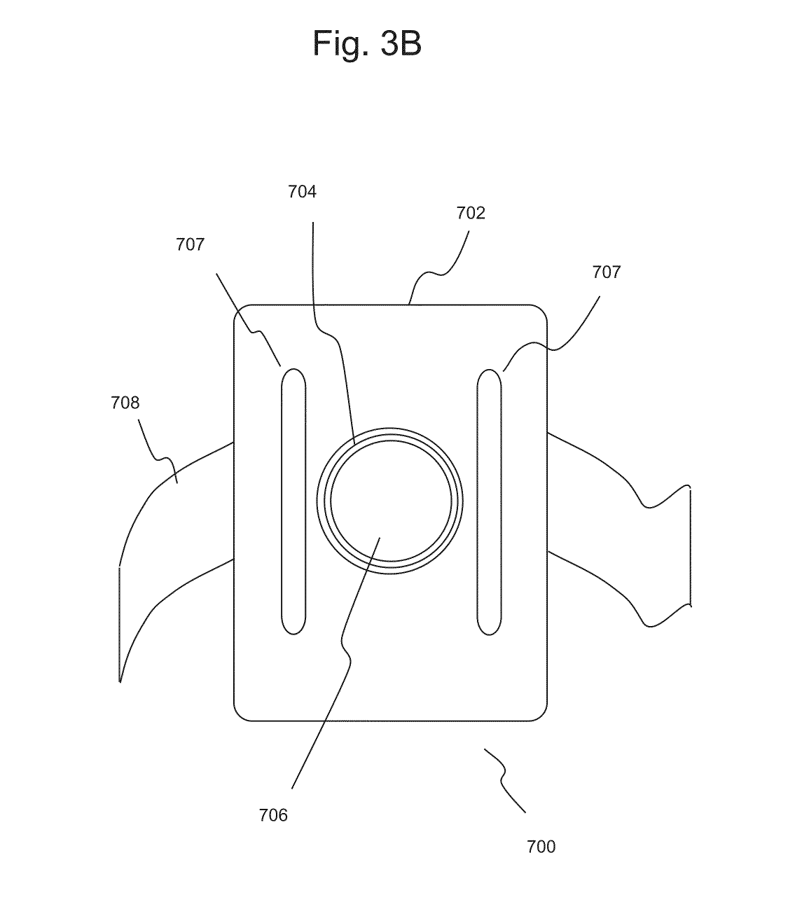

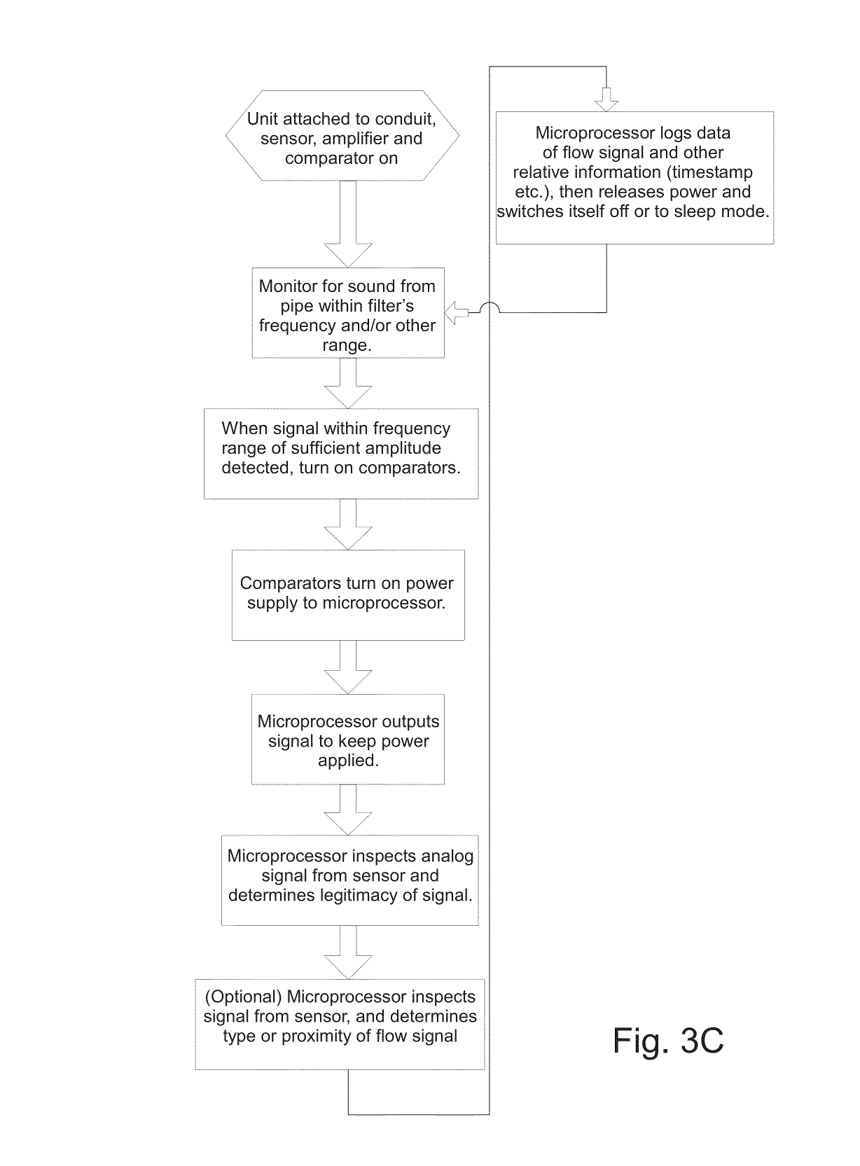

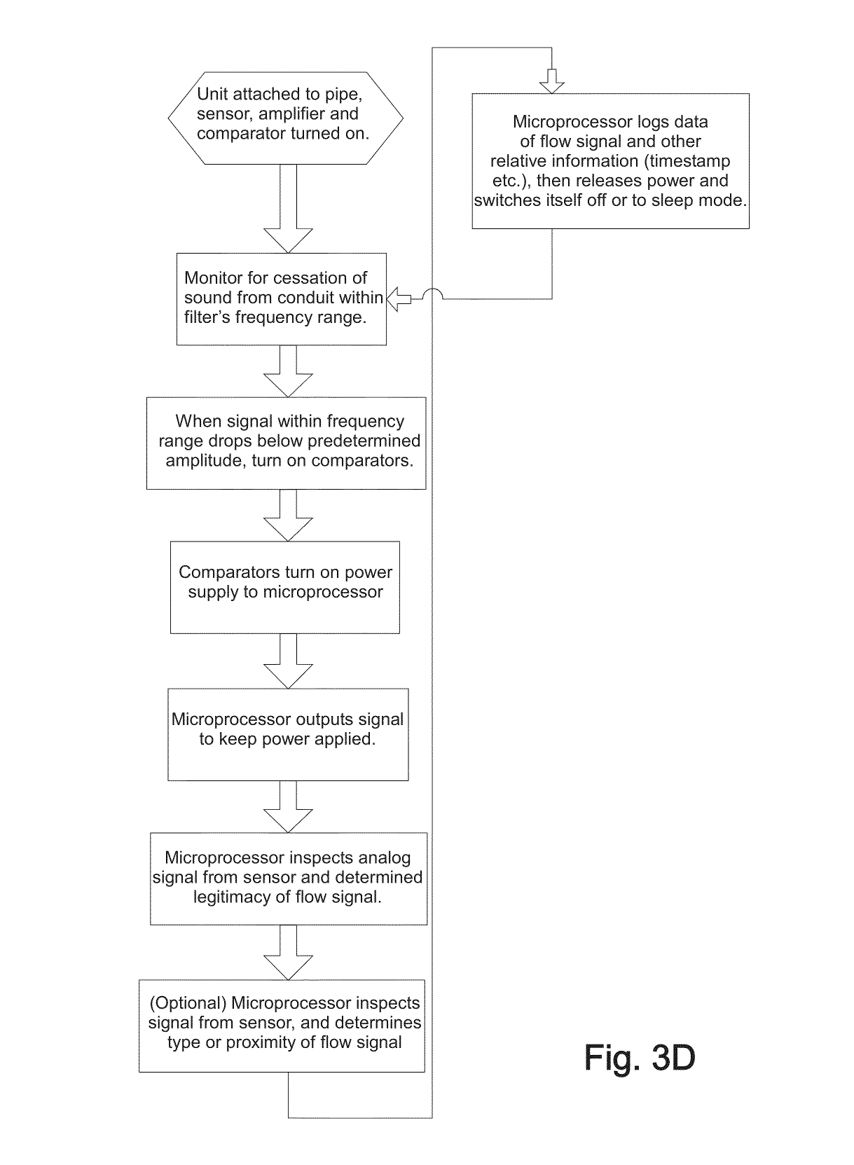

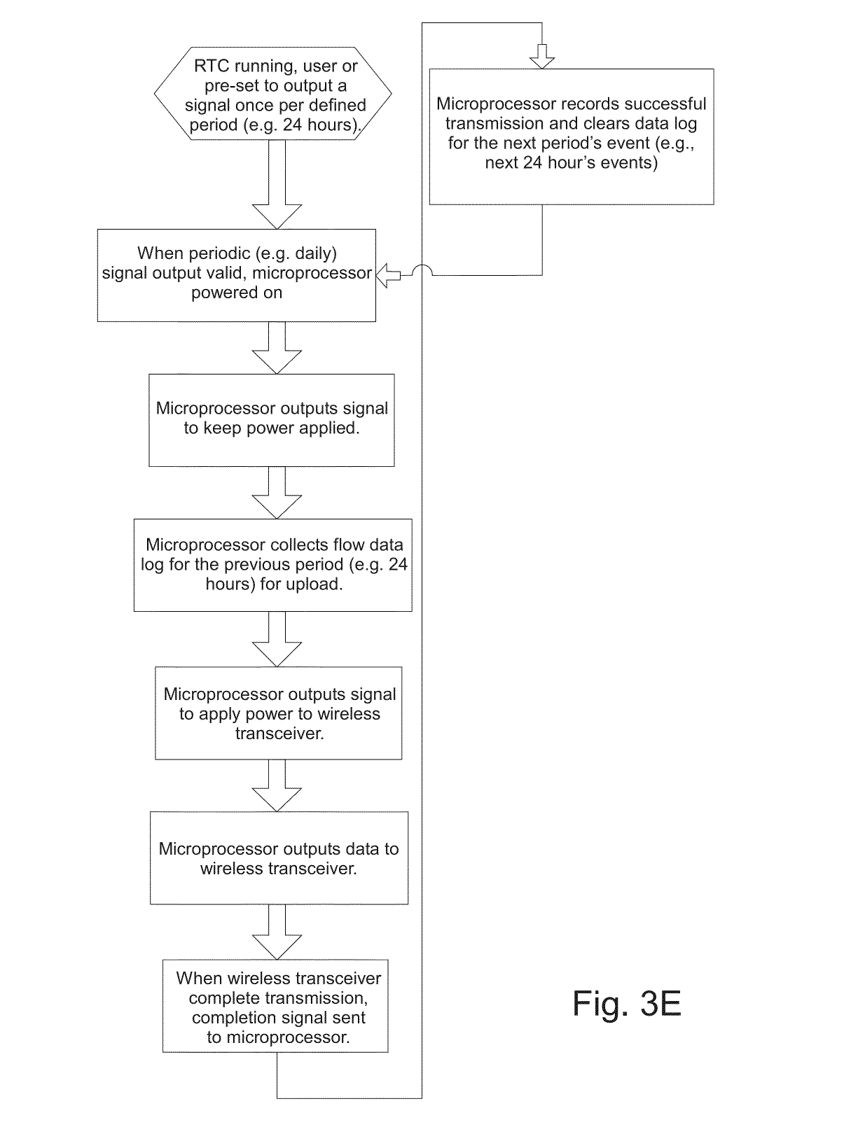

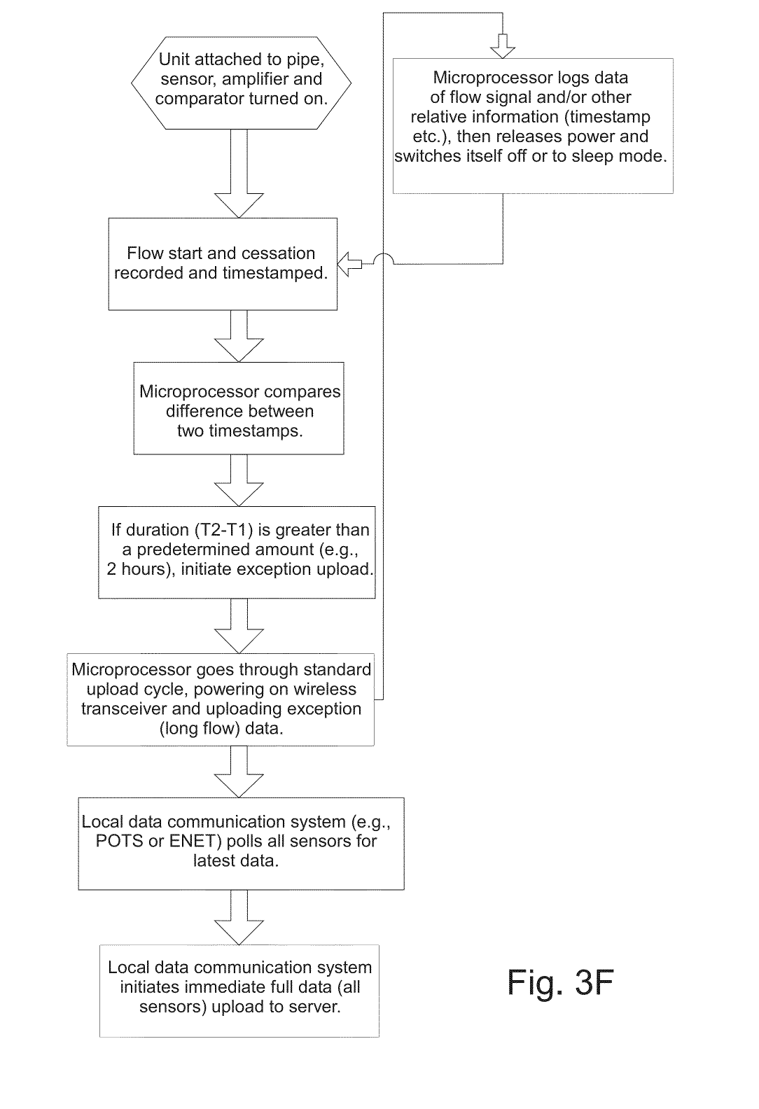

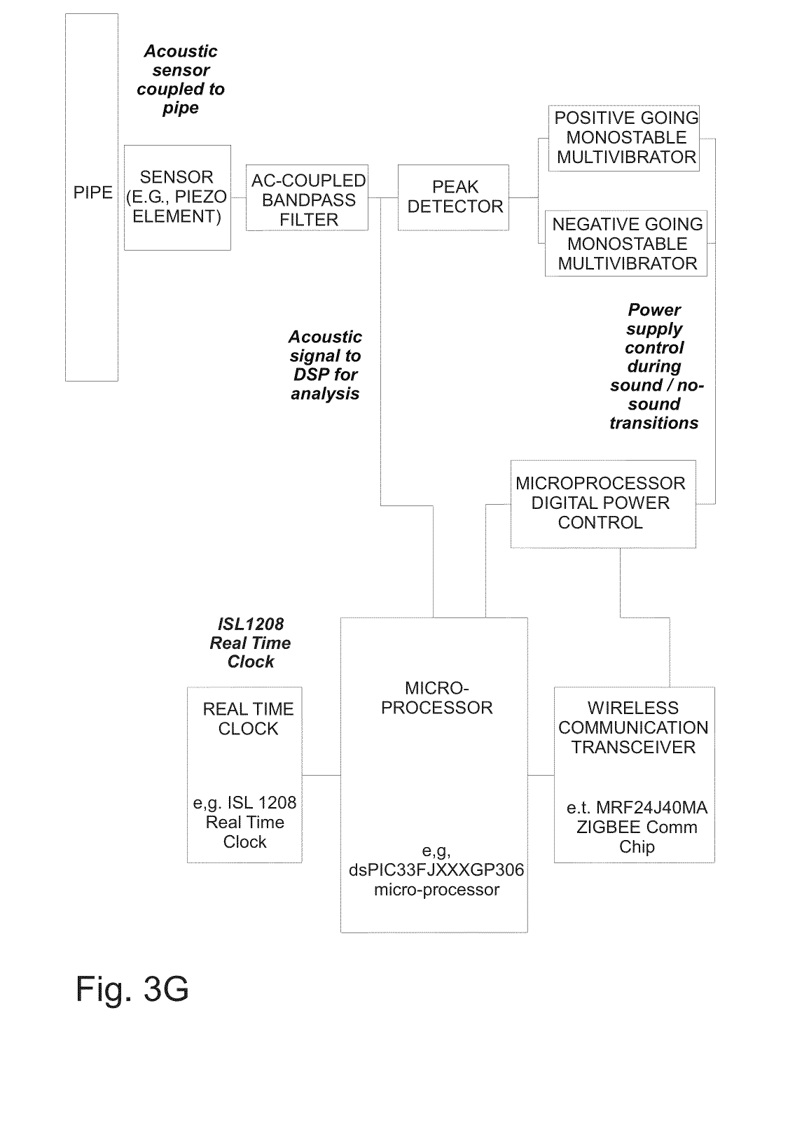

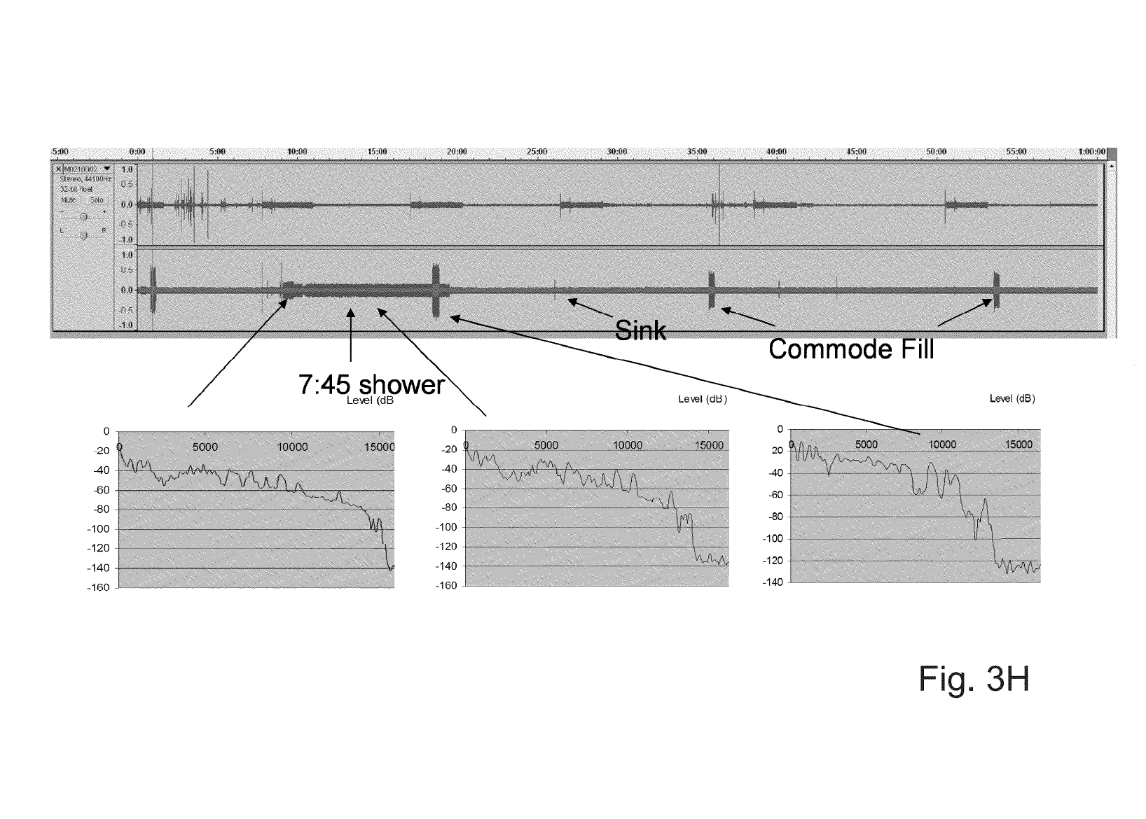

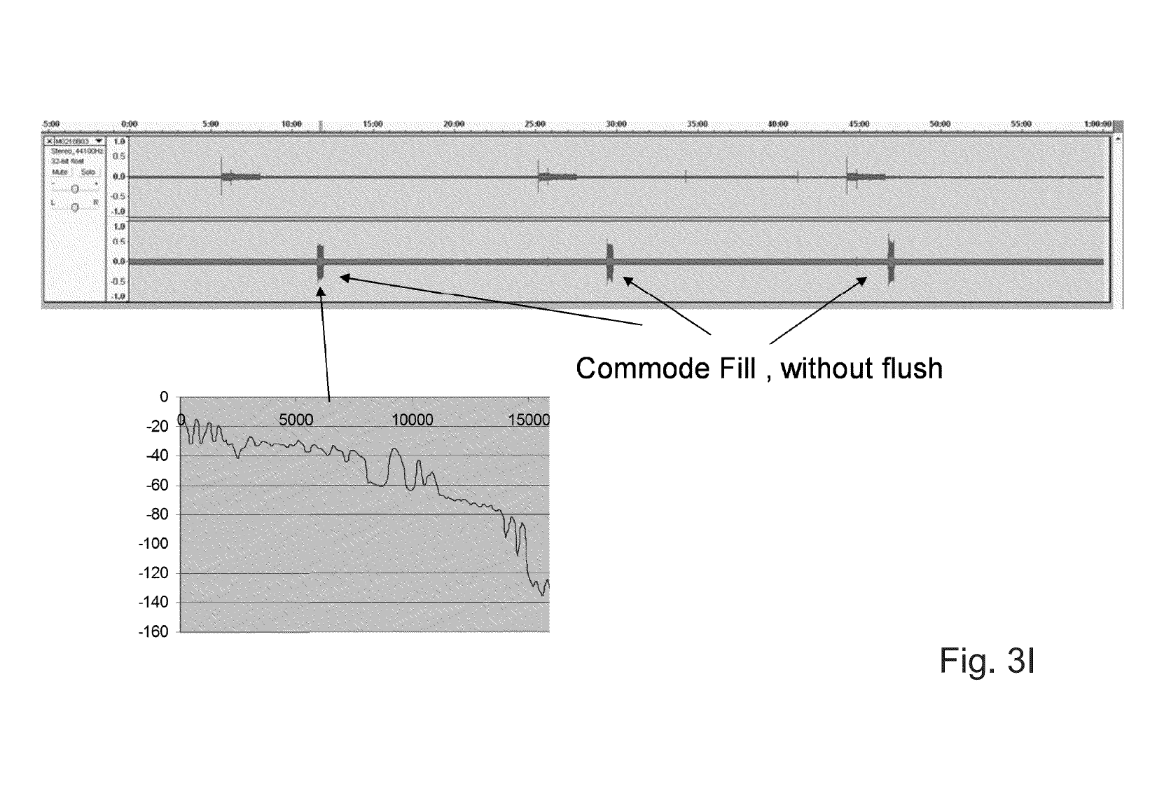

As illustrated in, for example, FIG. 3A a representative embodiment of a water use sensor system 700 includes an acoustic sensor 710 (for example, a piezoelectric acoustic sensor. In a number of representative embodiments, acoustic sensor 710 may, for example, may be used to monitor a frequency range of approximately 1 Hz to approximately 50 kHz or a range therebetween. In a number of embodiments, the frequency range is approximately 20 Hz to 20 KHz. An example, of an acoustic sensor suitable for use herein is the CUI CEB-20D64 available from CUI Inc. of Tualatin, Oreg. Sensor 710, associated electronics and a power source or power supply 720 (for example, a battery pack or an alternating current power source) are integrated into a unit within a housing or case 702. As illustrated schematically in FIG. 3A, sensor system 700 is placed in operative communication with a conduit such as a water pipe 800 (for example, the main water supply line or pipe of space/residence 5. As used herein, the term “conduit” refers to any entity through which or from which water may flow. In general, as acoustic signals (for example, sound) from one portion of a water conduit or piping system are conducted to other portions of the water conduit system via the conduits and other mechanical linkages of the water conduit system, sensor system 700 may be placed in operative connection or communication (either directly or indirectly) with a conduit or mechanical linkage of the water conduit system (for example, the water piping system of a house or apartment) at almost any point in the water conduit system to receive acoustic signals from any other point in the conduit system (for example, upstream and downstream of the position of sensor system 700 and in other branches of the conduit system). In that regard, acoustic signals can be received from any place in the water conduit system that is mechanically linked (via piping, connectors, tanks, etc.) to the conduit location or point at which sensor system 700 is positioned. In a number of embodiments, sensor system 700 is placed in operative connection with an inlet pipe supplying water to space 5.

As illustrated in FIG. 3B, a rearward or contact side of housing or case 702 includes an opening 704 wherein a coupling medium 706 (for example, a rubber disc) is positioned (to, for example, sonically couple acoustic sensor 710 to water pipe 800. Housing 702 may, for example, include centering ribs 707 or curvature on the rearward side of housing 702 to properly locate sensor 710 with respect to water pipe 800 to which sensor system 700 is attached. The physical attachment of sensor system 700 to water pipe 800 may, for example, be accomplished by a connector 708 such as a VELCRO® fastening strap (that is, a fastening strap including a hook-and-loop connector system) or another user-adjustable fastening strap.

In a number of embodiments, housing 702 is adapted to be attached to either or both of water inlet pipes and drain pipes. Such pipe may, for example, have a range of outside diameters (o.d.) in the range of approximately ¼ inch to 4 inches. Pipe 800 or other conduit to which sensor system 700 is attached may be formed from any of a number of materials, including, but not limited to, metallic materials and polymer materials (for example, copper, steel, plastic (such as polyvinylchloride or PVC), etc.). Insulation on a conduit may, however, diminish the coupling of acoustic sensor 710 to acoustic signals (for example, sound) caused by water running through the conduit.

As described above, sensor 710 may, for example, be a piezoelectric transducer. Such a piezoelectric transducer may, for example, include 2 or 3 terminals and be affixed to a printed circuit board or PCB assembly. Sensor 710 may, for example, be in physical contact with coupling medium 706. As described above, coupling medium 706 may, for example, be formed from a rubber material (or other material which transmits an acoustic signal). Coupling medium may, for example, protrude through the wall of housing 702 to physically contact pipe 800 or other conduit which is to be monitored to acoustically connect sensor 710 to pipe 800 or other conduit. Coupling medium 706 and/or an additional or optional spacing coupler (not shown) may be adapted or formed to conform to surfaces of various shapes (for example, a cylindrical surface, a flat surface, an irregular surface or other shaped surface).

Sensor system 700 may include one or more additional sensors 730. For example, a temperature sensor may be used to measure the temperature of the surface of pipe 800 or other conduit to which sensor system 700 is attached to measure temperature or change in temperature, which may provide an additional indication of flow. Moreover, temperature (and/or other ambient conditions) can affect the performance of sensor system 700, and a measurement thereof can be used to adjust the output of sensor system 700 or to indicate that the accuracy of sensor system 700 may be questionable (for example, in the case of an excessive temperature for effective operation of the electronic circuitry of sensor system 700). Suitable temperature sensor may, for example, be of a contact variety, including, but not limited to, thermistors, thermocouples or silicon-based temperature sensors, or be of a non-contact variety, including, but not limited to, infra-red thermal sensors. Additionally or alternatively, a condensation sensor may be provided to, for example, be in contact with pipe 800 (or other flow conduit or, reservoir) to measure flow, humidity or differential temperature. A temperature sensor may, for example, be used to determine if sensor system 700 is attached to a hot water conduit or a cold water conduit (as sensor system 700 may be attached to either to monitor acoustic signals arising from flow anywhere in the conduit system). Changes in temperature may further be indicative of flow through the conduit. Also, a temperature sensor in sensor system 700 may be used to ensure that a hot water system is operating in a desirable and safe temperature range.

Power supply 720 of sensor system 700 may, for example, include one or more batteries for increased safety (in a potentially damp or wet environment) as compared to AC power supplies and/or to facilitate connection to conduit or pipe 800 (which may be positioned remote from any electrical outlet). In a number of embodiments, acoustic sensor 710 is powered to monitor acoustic signals (for example, sounds) from pipe 800 continuously or substantially continuously while one or more other components of sensor system 800 are allowed to remain in a sleep mode or in a powered off until triggered to awaken to conserve power. Sensor system 700 may, for example, further include circuitry in connection with the acoustic sensor 710 to determine if the predetermined condition (associated with a flow event or condition) is met. Once such a condition is sensed or determined, one or more other components that are in a sleep mode or a powered off mode may be powered. Acoustic sensor 710 may, for example, be connected to a high-impedance amplifier, with input protection against transients generated by mechanical shock to the transducer, and AC-coupling and feedback to form a bandpass amplifier 740, of an amplitude and/or frequency range consistent with that of the acoustic signature of water or other liquid flowing through or from a conduit such as pipe 800 of, for example, a size commonly found in a residence or other facility housing person 5 and/or other people.

In a number of embodiments, the output of bandpass filter/amplifier 740, is, for example, transmitted to a number of comparators or a comparator network 750. The inputs of comparators 750 may, for example, be rectified and filtered, such that short-duration noise is rejected, while longer-term (that is, greater than a threshold duration such as, for example, greater than 1 second) noise is recognized as a potentially valid flow signal. The rectified and filtered signal presented to comparators 750 may, for example, be measured against a reference voltage, which may be dynamically adjustable (for example, by a microprocessor 770) for a threshold which is accepted as a valid potential flow signal. The reference voltage and/or the gain of the amplifier may be adjustable.

Flowcharts for embodiments of several methodologies for the operation sensor system 700 are set forth in FIGS. 3C through 3F. As illustrated in FIG. 3C, in a number of embodiments, when a valid potential flow signal is determined, the output of at least one comparator 750 may, for example, enable power source or supply 720, which will apply power to processor 770 (for example, a microprocessor such as a PIC DSPIC33FJ128GP306 available from Microchip Technology Inc. of Chandler, Ariz. or a similar device), for the purpose of recording the onset of flow and other functions. Processor 770 may, for example, take control of power supply 720 enable power to itself, and maintain power to itself until it has performed all of its programmed functions. Processor 770 may, for example, inspect the analog signal from bandpass amplifier 740, for further analysis of the signal, to determine if it is indeed flow or other random noise. In a number of embodiments, processor 770 may utilize FFT (Fast Fourier Transform) or other methods to analyze the signal from bandpass amplifier 730 to determine its validity as a legitimate flow signal and/or to associate the signal with a particular activity (for example, showering, dishwasher activity, washing machine activity, faucet activity etc.).

Once a valid flow signal has been established, processor 770 may, for example, time-stamp and record the time of flow onset to memory. The time-stamp signal may, for example, be derived from an internal or external RTC (real-time-clock) or other time reference. After recording the beginning of flow and completing all other housekeeping duties, processor 770 may, for example, release the power supply enable signal, powering itself off.

As illustrated in FIG. 3D, when the flow signal from bandpass filter/amplifier 740 drops below a certain threshold, a second comparator 750 may be triggered, which will enable power supply 720 and power on processor 770. Processor 770 may inspect the comparator output, and may also inspect the raw analog signal from bandpass filter/amplifier 740, to ascertain that flow has indeed ceased. As described above processor 770 may take control of power supply 720, enable power to itself, and maintain power to itself until it has performed all of its desired functions. Processor 770 may, for example, record the time of flow cessation to memory, and may also calculate the duration of flow, based on the time of cessation minus the time of flow onset, and record this to memory.

As illustrated in FIG. 3E, on a scheduled basis (for example, periodically such as once per day), the real-time clock may initiate a signal to apply power to processor 770 and to a wireless communication transceiver 780 (for example, a Microchip MRF24J40MA-I/RM or similar device using, for example, a ZIGBEE protocol) to upload all flow events (or lack of flow events) to local data communication device 150 since the most recently preceding scheduled upload. Applying and holding power on processor 770, and subsequently releasing the power enable signal can be effected as described above.

As illustrated in FIG. 3F, if a defined threshold condition is determined (for example, if the time of flow calculated exceeds a predetermined threshold), processor 770 may, for example, initiate an upload on exception, and output a signal which will enable/power a wireless communication system 780. Communication system 780 may then transmit data to, for example, local data communication device 150. The transmitted data may, for example, include the time and duration of flow. Processor 770 may also, for example, additionally upload other flow events for a predetermined preceding time period or since the most recent scheduled upload. After recording the data and any other relative information and completing all other housekeeping duties, the processor 770 may, for example, release the power supply enable signal, powering itself off. The power conservation methodologies described above may, for example, conserve battery power.

A circuit diagram for the embodiment of sensor system 700 illustrated schematically in FIG. 3A is illustrated in FIG. 3G.

In a number of embodiments, acoustic sensor or acoustic sensor system 710 includes more than one acoustic sensor or an acoustic sensor with more than one channel. FIG. 3H illustrates analog data over a period of time from acoustic sensor 710 of sensor system 700 (a piezoelectric transducer) including two channels. A first (upper, in the orientation of FIG. 3H) channel monitored ambient or environmental acoustic signals (for example, sound) and a second (lower) channel monitored acoustic signals (for example, sound) from pipe 800. Monitoring or measuring ambient acoustic signals, sound or noise facilitates the determination that acoustic signals measured by the second channel correspond to a valid signal (that is, a signal associated with water flow through pipe 800).

The second (lower) channel illustrates acoustic signals corresponding to water flowing through pipe 800 and associated with a shower running, a sink running, and filling of a commode. FIG. 3H also illustrates three spectra showing amplitude versus frequency for several sections of the acoustic signal from pipe 800. Various algorithms such as, for example, fast Fourier transform algorithm may be used to, for example, assist in determining that a signal is a valid signal associated with flow through pipe 800. Various variables and/or analytical methods such as amplitude, duration, timing, periodicity, spectral analysis etc. can be used to determine that a signal is a valid signal of flow through pipe 800 and not an invalid or ambient acoustic signals, including, for example, sound associated with flow through another conduit (for example, flow through a pipe in a neighboring apartment other space).

In a number of embodiments, sensor system 700 is adapted to improve its ability to determine if a signal from pipe 800 or other conduit is associated with flow therethrough. In a number of such embodiments, one or more algorithms of sensor system 700 may be adaptive with respect to, for example, amplitude of an acoustic signal corresponding to flow and/or to frequency/bandwidth associated with flow events. Adaptive algorithm(s) may, for example, use gain modification, bandwidth modification or a combination of both to permit sensor system 700 to differentiate between a valid flow signal and noise unrelated to flow within conduit 700.

In addition to monitoring water usage for the purpose of monitoring wellbeing of person 5, sensor system 700 can also provide information regarding the operation of various systems in space 10 which use water. FIG. 3I illustrates additional analog data from the two channels of acoustic sensor 710 over time. In FIG. 3I a periodic acoustic signal (which was also present in the data of FIG. 3H) is associated with periodic filling of a commode reservoir without and associated flush of a commode. The periodic signal is associated with a leaking commode.

Variable such as amplitude, duration, timing, periodicity, patterns of flow events and analytical methods such as spectral analysis can also be used to determine the type of activity with which water flow is associated (for example, a shower, faucet usage, commode usage etc.). Sensor system 700 may, for example, be calibrated specifically for a water conduit system of space 5 and/or include data from multiple water conduit systems (for example, in the form of look-up tables and/or algorithms) to assist in validating flow and/or determining a type of flow. Pattern matching may, for example, be used to determine the type of water usage. In a number of embodiments, sensor system 700 is used primarily to determine whether a valid flow event is occurring and to upload the timing and duration of such flow events to local data communication device 150. In a number of such embodiments, a determination of one or more activities associated with one or more flow events may, for example, be determined (at least in part) in remote system 200.

Information from sensor system 700 may, for example, also be used for security monitoring or for monitoring for unauthorized use. In that regard, water usage or a particular type of water usage sensed by sensor system 700 may be associated with an unauthorized access to space 5 or a portion thereof. For example, if space 5 is to be unoccupied for a period of time (for example, during a particular season in the example of the occupant(s) travelling south for winter months), detected water usage or a particular type of water usage may be associated with the presence of an intruder. Sensor system 700 may, for example, be integrated with or placed in communication with many types of security systems in new installations and via retrofitting or addition to existing systems.

One or more sensor systems can, for example, be used to measure one or more variables related to rest and/or sleep (for example, the duration of time that monitored person 5 is lying in bed, sitting in a chair, sitting on a sofa etc.), which are important parameters for monitoring the wellbeing of person 5. In addition to the duration of time spent in bed, the time of going to bed, the time of waking up and the time and duration of interruptions of sleep (such as associated with the use of the restroom in the middle of the night), may also be recorded. Failure to get out of bed by a certain time, for example, may be indicative of a problem requiring immediate attention (and defined as an exception event required an expedited or immediate upload of data to remote system 200).

Monitoring of bed usage can, for example, be accomplished in various manners including, for example, use of a pressure sensitive pad placed on or under the mattress of the bed to indicate the presence of a person in bed, or the use of a pressure sensor located on or under a leg of the bed and designed to monitor change in weight, thereby indicating the presence of a person in bed. Other sensor systems for sensing the presence of a person in a bed may, for example, include piezo resistive films, thick film strain sensors, infrared sensors, accelerometers, acoustic sensors, carbon dioxide sensors and/or body temperature sensors.

Sensor systems can also be used in connection with one or more medical devices (for example, diagnostic or treatment devices) used in connection with the monitored person's body or medical care. For example, dental CPAP appliances are sometimes used to treat persons suffering from obstructive sleep apnea. Compliance with dental CPAP device therapy is, on average, less than 60% in the United States. One or more sensors can, for example, be used to monitor persons using dental CPAP appliances, and track the hours of usage of such devices. A sensor system can, for example, be placed on the side of the dental CPAP device, which, when in use, resides in the person's mouth and senses the use of the dental CPAP device by, for example, sensing changes in temperature or conductivity in the person's mouth. The data can then be transmitted to remoter system 200 for compliance tracking purposes.

In another embodiment, one or more sensor systems can, for example, be placed in operative connection with a continuous positive airway pressure or CPAP device (or other positive airway pressure of PAP device) often used by persons suffering from obstructive sleep apnea to monitor, for example, compliance. For example, a CPAP sensor can transmit data of the on time, the off time, the usage time, and the average pressure rather than transmitting a stream of analog data, which is then interpreted on the server side.

Persons undergoing treatment for chronic or other health conditions in the home such as obstructive sleep apnea (OSA) and other conditions require frequent monitoring. A comprehensive monitoring program involves the collection of both quantitative and qualitative metrics. While quantitative metrics are most easily collected using sensors and associated devices, qualitative methods generally require an interaction with the person using a variety of systems and/or methods, including conversations over the phone, internet, SMS methods, or via mail.

Using conventional manual methods, a nurse or healthcare provider typically reviews the output of quantitative metrics from sensors and modifies a conversation with person 5 accordingly to collect the most appropriate qualitative data possible. When utilizing automated or semi-automated methods, however, such as IVR, web-based surveys, or similar methods, it is difficult to dynamically change the qualitative data collection based upon sensors, thereby reducing the effectiveness of the qualitative monitor and increasing the number of questions and/or surveys required of person 5 (which contributes to dissatisfaction).

In a number of embodiments hereof, a medical device monitoring device or system (for example, a PAP monitoring device) collects usage, compliance, and clinical efficacy data. The device can be used in conjunction with a management tool incorporated within or operating in conjunction with monitoring system 50 that is, for example, at least partially automated to contact person 5 (utilizing, for example, IVR, SMS, email, and/or internet communication methods) whereby the questions asked and the data collected via the management tool are changed based upon the data being collected from the PAP monitoring device.

For example, current OSA patient management technology asks a patient or person how long and how frequent they have been using their therapy. With the incorporation of the PAP monitoring device, rather than asking how long they've been using their therapy, the management tool can tell them how long they've been using it and offer feedback (positive or negative) to the person. Such a methodology provides a more effective monitoring with higher satisfaction.

As discussed above, transmitting state-based or value-based data (for example, periodically) reduces cost, lowers bandwidth usage, and requires less memory as compared to continuous, real-time transmission of analog data. The transmission of state-based data hereof to remote system 200 may be in a batch manner as described above or may be continuous or substantially continuous in, for example, the case of an available broadband connection between local system 100 and remote system 200. As further described above, in the case of some type of devices such as medical or physiological devices which monitor movement or physiological parameters (for example, temperature, heart rate etc.) it may be desirable to transfer data at very short periods or even continuously. For such monitoring systems it may be desirable to include a communication module in the associated sensor system for continuous transmittal of data to, for example, local data communication device 150 and ultimately to remote system 200. Table 2 provides a summary of several devices describing the functions or activities monitored, the data type to be transmitted to the remote system 200 and whether the transmission of such data may, for example, be periodic or continuous in a number of embodiments hereof.

TABLE 2

| Item being | Description of what | | Periodic and/or continuous |
|---|---|---|---|
| monitored | monitored | Data type | monitoring/uploading |
| Sleeping patterns | Monitor when the person | Hours, Times of changes | Periodic (but may require timed update |
| | is and is not in bed | of status | that is programmable or an hourly |
| | | | update) |
| Television | Monitor when the | Hours, Times of changes | Periodic (daily update may be |
| | television is on and off | of status | sufficient) |
| Refrigerator | Monitor the times that the | Times of changes in | Periodic (daily update may be |
| | refrigerator is opened. | status | sufficient) |
| Oven | Monitor the times that the | Times of changes in | Periodic (daily update may be |
| | oven is on. | status | sufficient) |
| Microwave | Monitor the times that the | Times of changes in | Periodic (daily update may be |
| | microwave oven is on. | status | sufficient) |
| Lights/lamp | Monitor the times that the | Hours, Times of changes | Periodic (daily update may be |
| | light is on. | of status | sufficient) |
| Water | Measure water flow at the | Hours, Times of changes | Periodic (daily update may be |
| consumption | water intake pipe of the | of status | sufficient) |
| | house or at any desired | | |
| | water-using device. | | |
| Patient physiology | Temperature, heart rate, | Depends upon | May be periodic with increased |
| | blood pressure etc. | physiological parameter | frequency of upload or may be |
| | | being monitored | continuous |

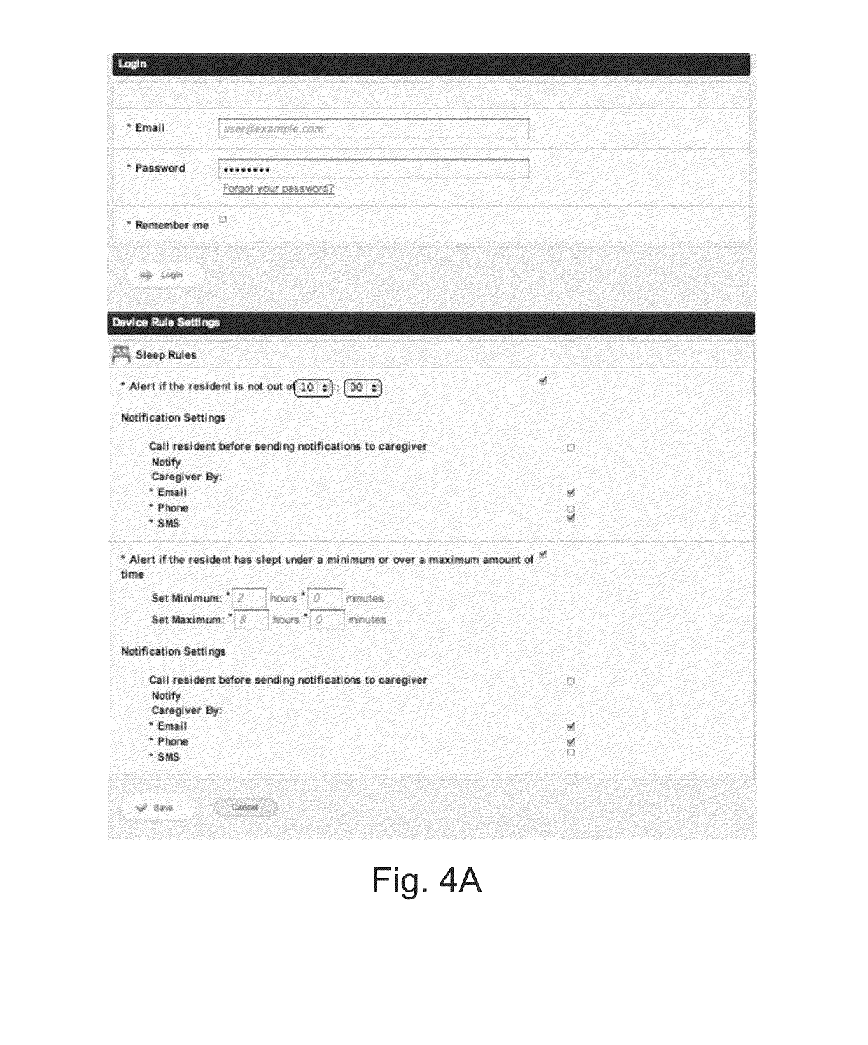

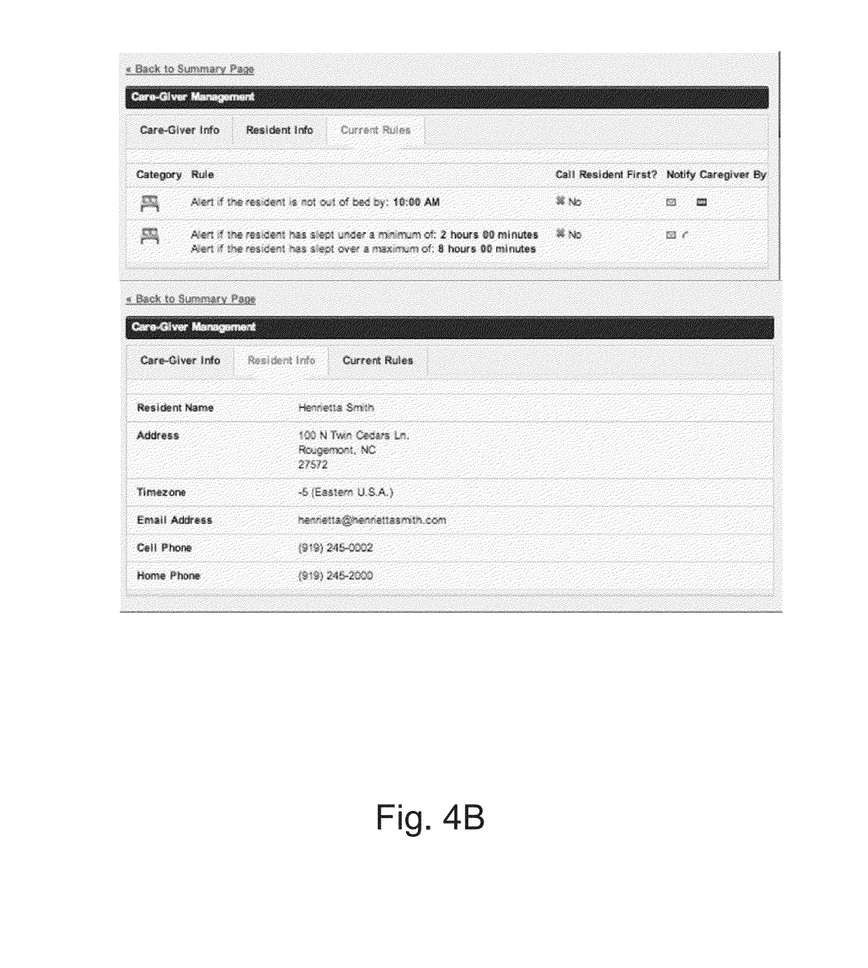

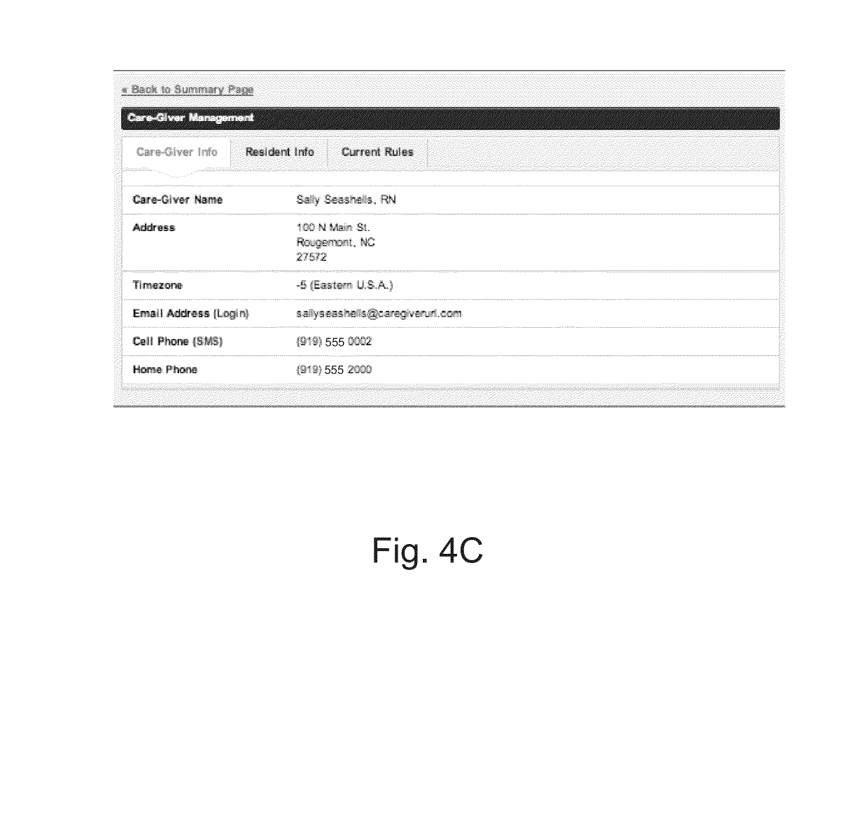

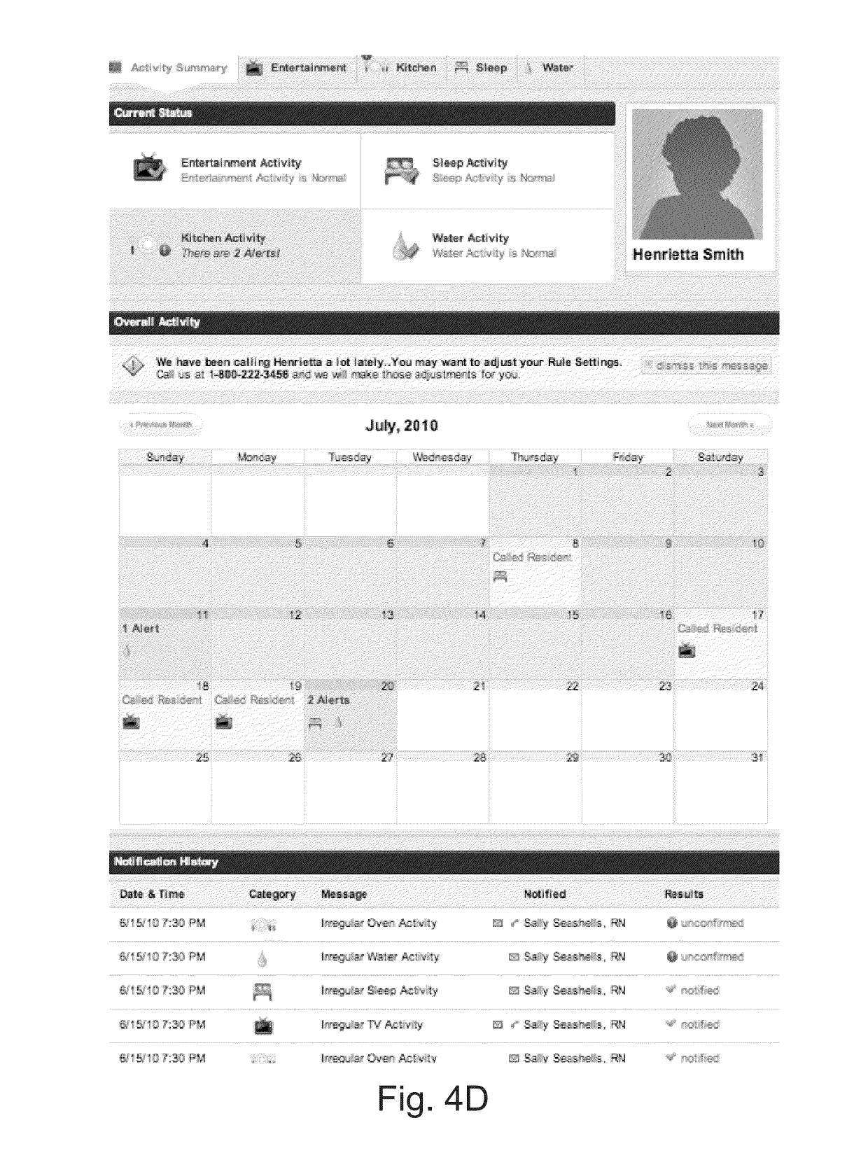

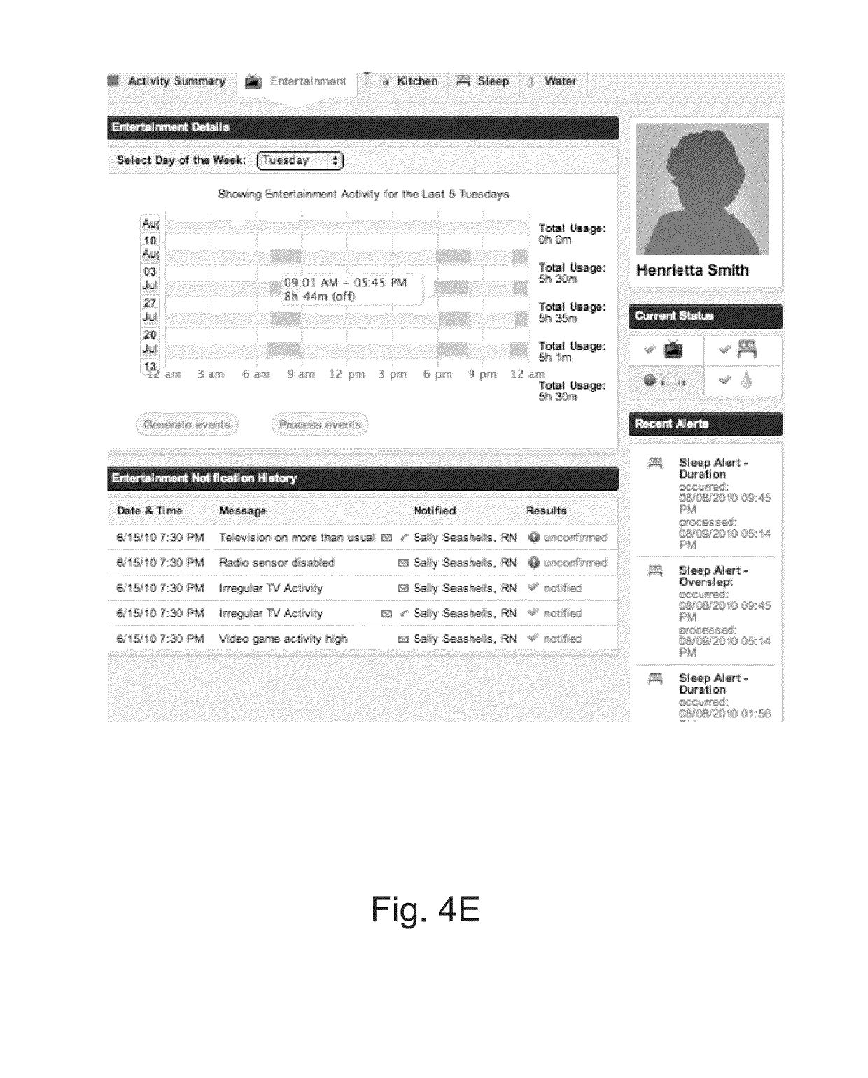

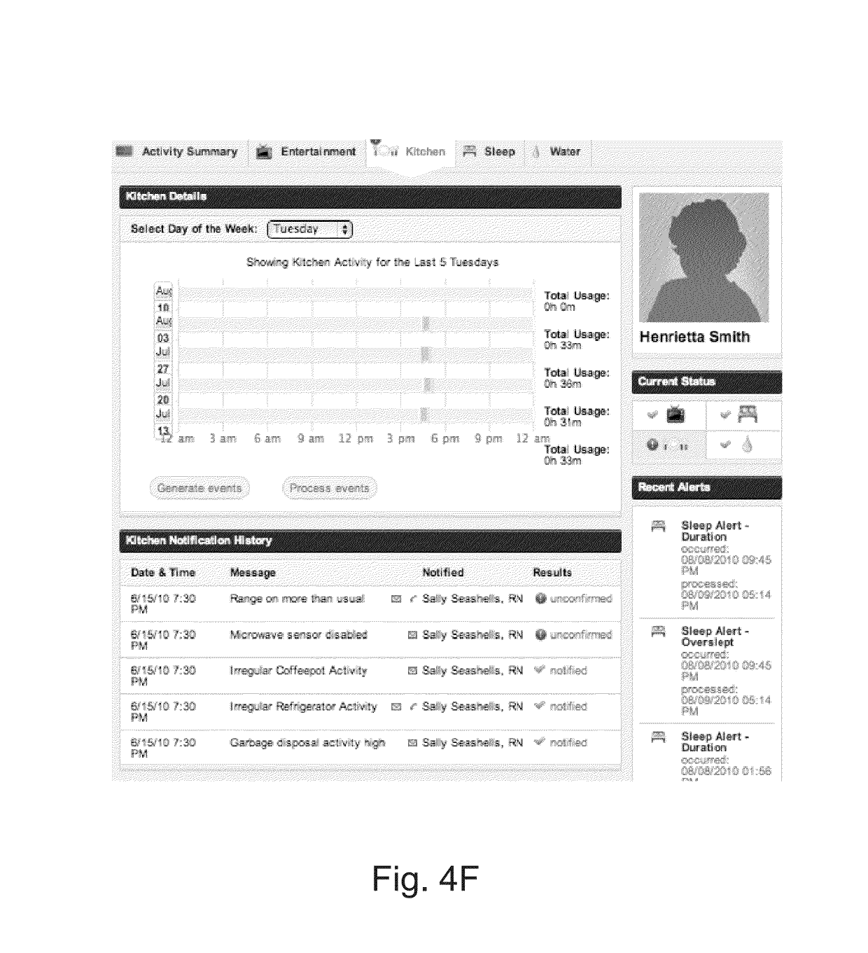

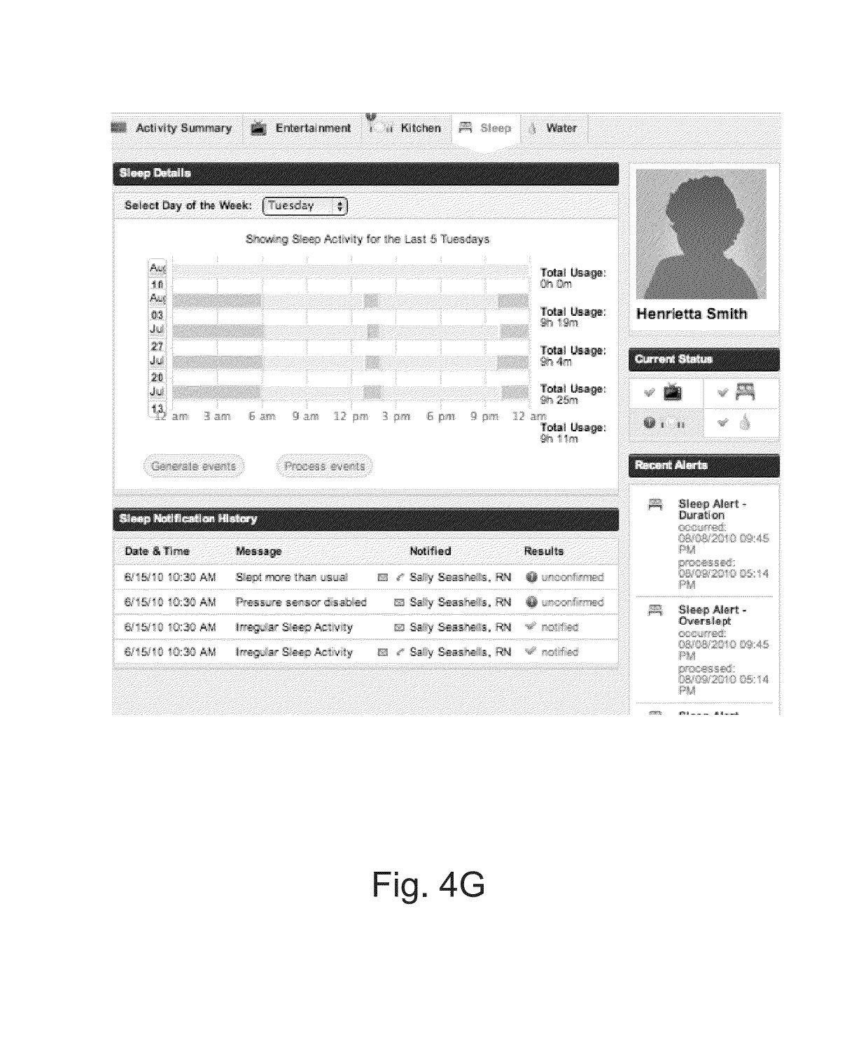

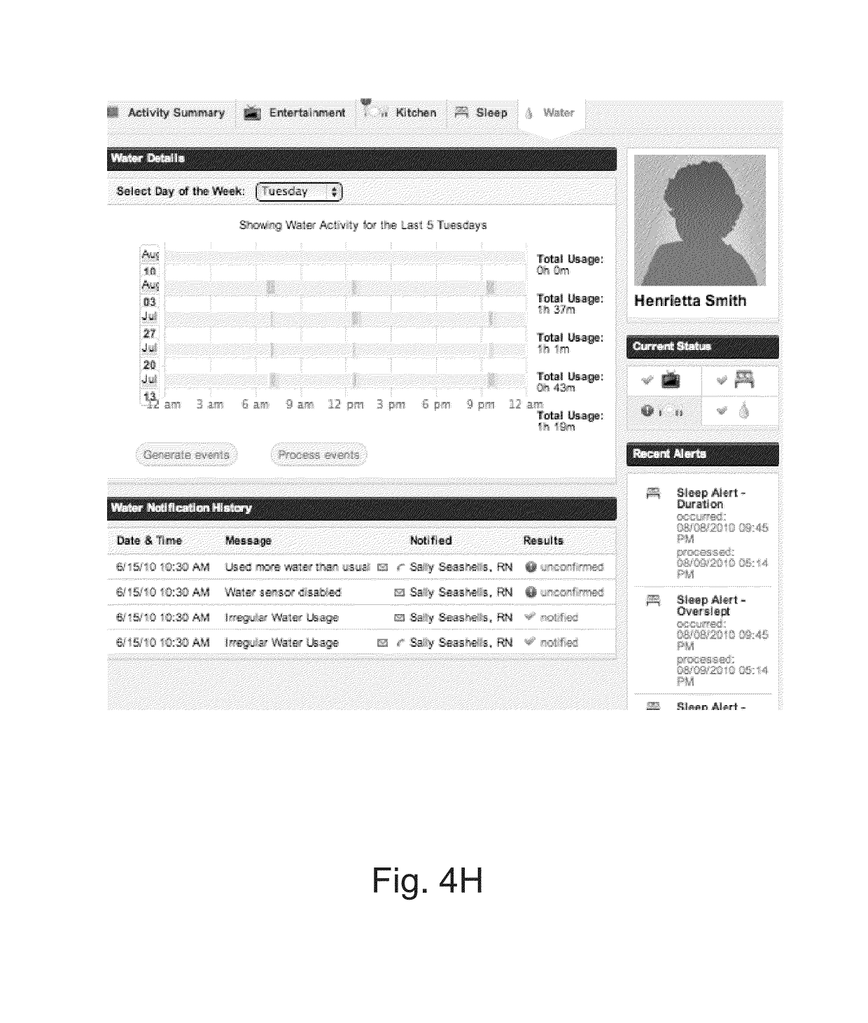

FIGS. 4A through 4H illustrate representative embodiments of computer screen captures from sever-based programming of remote system 200 which are representative of the setup and function of a number of aspects of the systems and methods hereof. In that regard, one or more users or system operators are provided with display/interfaces (for example, web pages via a graphical user interface) to enable setup, configuration, review etc. of monitoring system 50 and the components thereof (see, for example, FIG. 1B).

FIG. 4A illustrates an embodiment of a screen for login and for monitored device rule settings. In that regard, FIG. 4A sets forth a number of rules for the monitored persons sleep activity and associated alerts. FIG. 4B illustrates an embodiment of a screen summarizing rules for alerts to caregivers related to bed activity and an embodiment of a screen summarizing resident information.

FIG. 4C illustrates an embodiment of a screen summarizing caregiver information. FIG. 4D illustrates an embodiment of a screen setting forth an activity summary screen derived from state-based sensor data. Server system 210 can, for example, include logic or learning algorithms to notify an operator of possible modifications (for example, rule changes) that might be desirable to improve operation based upon past actions or experiences (for example, excessive alerts, false alerts etc.) Different categories of activities can, for example, be categorized for ease of viewing and/or analysis. As illustrated in FIG. 4D, a type or category of activity can be selected for viewing and/or analysis from a menu. FIG. 4E illustrates an embodiment of a screen setting forth entertainment activity derived from state-based sensor data from a television, a radio and a computer (video game activity). As illustrated in FIG. 4E, the time of uses and duration of uses can be set forth for a defined period of time. FIG. 4F illustrates an embodiment of a screen setting forth activity derived from state-based kitchen device sensor data from sensor systems associated with a range, microwave, coffeepot, refrigerator and garbage disposal. FIG. 4G illustrates an embodiment of a screen setting forth sleep activity derived from state-based sensor data from one or more sensor systems associated with a bed. FIG. 4H illustrates an embodiment of a screen setting forth water use derived from state-based sensor data from a sensor associated, for example, with a water utility inlet into space 10.

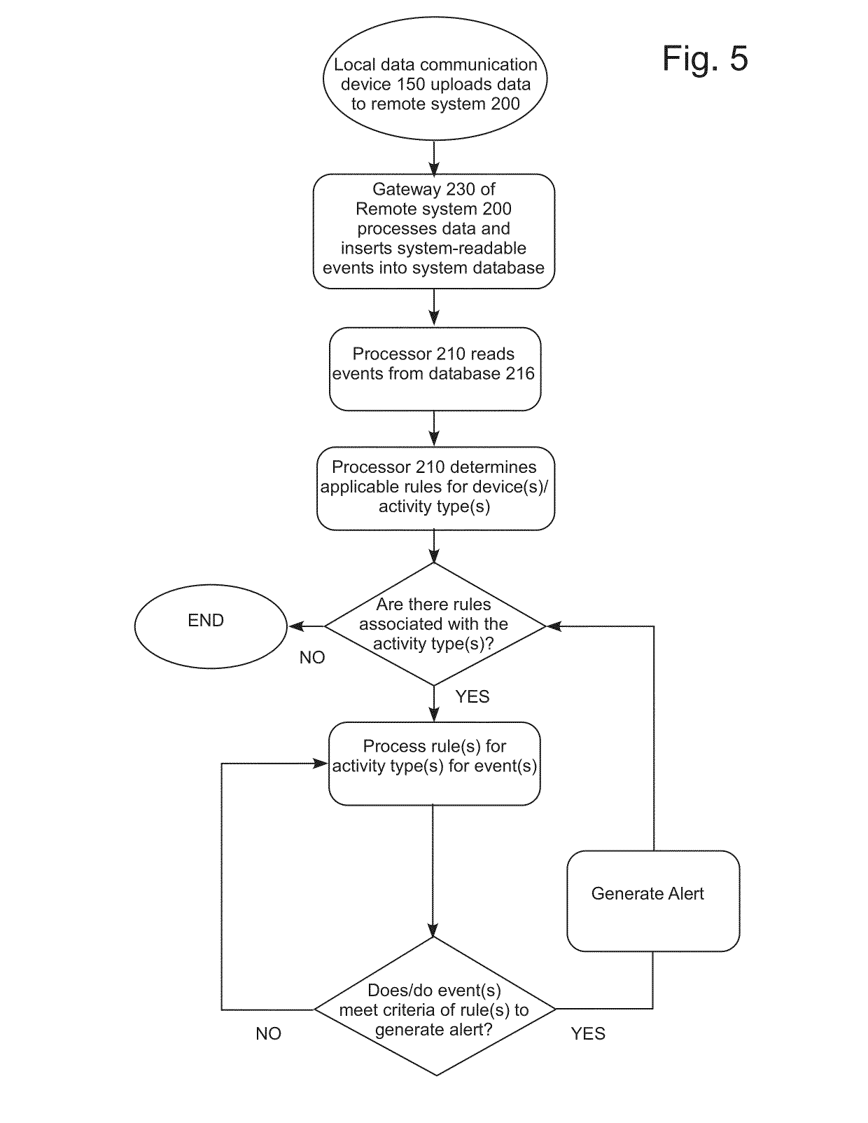

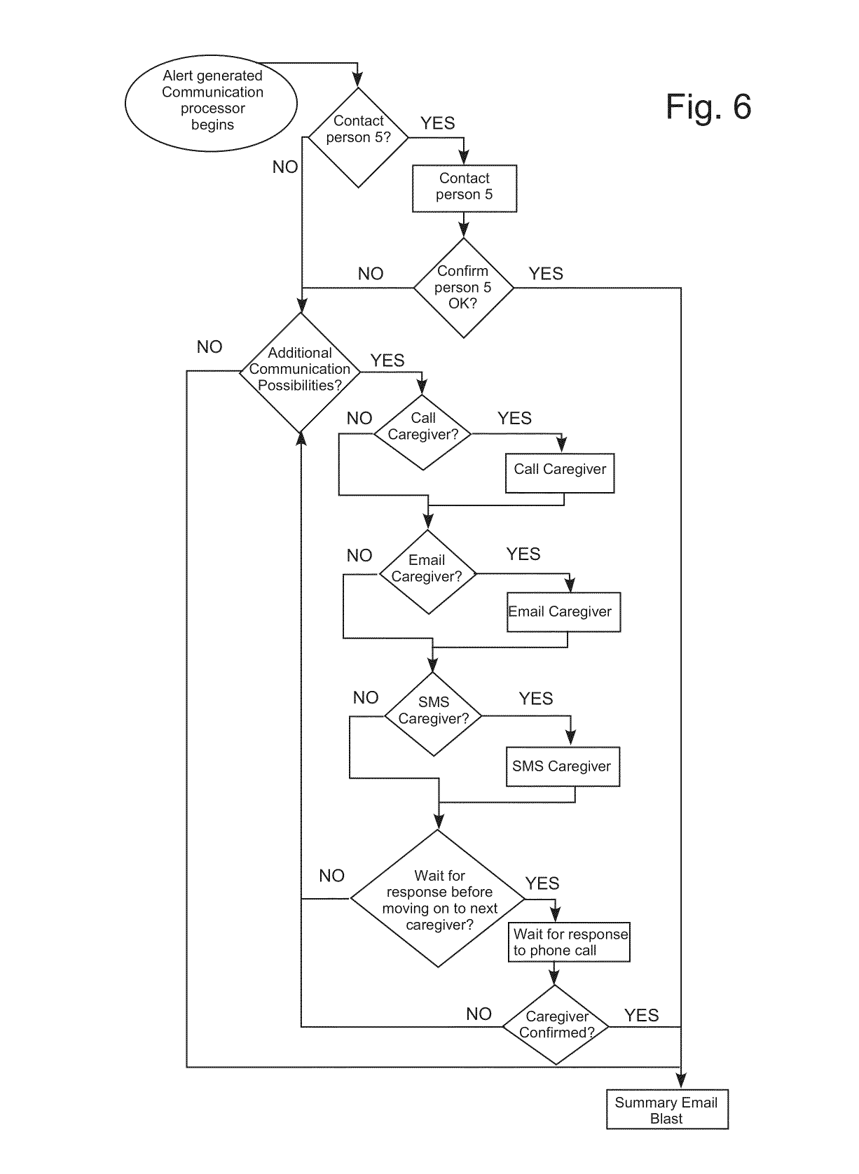

FIG. 5 illustrates a flowchart for an embodiment of methodology for the uploading of data to remote system 200, the determination of associated or relevant rules and the application of such rule to determine whether an alert should be generated. FIG. 6 illustrates a flowchart for an embodiment of methodology for alerting one or more caregivers via one or more communication devices or systems and including an optional attempt to confirm person 5 is OK via an attempt to communicate with or contact person 5.

When monitoring the wellness of person 5, it is necessary to track their behavior on a day to day basis. Such behavior, however, can change at different times of day and from day to day, based upon, for example, whether it is a weekend or a weekday, a holiday or a workday etc. If a wellness monitoring system is designed to generate alerts based upon personal behavior using the same alert thresholds or triggering events at all times/dates, the probability is significant that alerts will be falsely issued or missed on “special” days such as days away from home, weekends, vacations or holidays.

In a number of embodiments, one or more sensitivity settings can be adjusted for specific classifications of time of day and/or dates/days (for example, weekends, holidays, vacations or even seasons of the year). For example, a sensitivity setting can involve a high, medium, or low setting, and corresponding thresholds which change based upon the sensitivity setting and corresponding alerts. Such sensitivity settings result in more accurate alerts (for example, less false positives/negatives.). Moreover the timing of uploads of data from local system 100 to remote system 200 may be altered depending upon time of day and/or dates/days. For example, a frequency of upload may be changed (for example, from three times per day to once per day).

Regardless of system settings, and depending upon personal behavior and monitoring characteristics, there is always the possibility of false alerts being generated. Such false alerts can result in false alarms, lost productivity, and unnecessary expense.

In a number of embodiments of the systems and methods hereof, monitored person 5 can, for example, receive an automatic verification phone call and/or other communication prior to the generation of an alert to one or more remote caregivers. Such a phone call can, for example, attempt to verify that person 5 is in need of assistance to reduce false positives or false alarms.

As described above in connection with uploads upon exception, monitoring various parameters, devices or appliances individually does not take into account information that can be derived by looking at multiple devices at the same time and correlating data therefrom. For example, in the case of a person who has been in bed for a predetermined extended period while the kitchen range is on, in the case that lights are illuminated during off hours for an extended period of time, or in the case that heating/air conditioning settings and/or usage does not correlate with the outside temperature, the person might require assistance. Monitoring of one of these parameters alone or collectively with no correlation of the resultant data may not result in identification of the person's needs. In a number of embodiments, data from sensor systems monitoring devices/systems that are not related or would not be normally grouped together with regard to a particular activity are analyzed to identify anomalies or abnormalities indicative of a condition requiring an action such as an alert or an upload upon exception.

In a number of embodiments of the systems and methods hereof, an array or network of sensor systems operate in concert with each other and data therefrom is correlated such that the wellbeing of the monitored person can be tracked and exceptions and/or alerts can be generated based upon events or values from multiple sensor systems or parameters, tracked in parallel. The data for a plurality (including at least two) sensor systems is thus monitored and correlated using predetermined rules and/or logic to determine if the combination of data from the plurality of sensors indicate the need for an alert. More accurate alerts are thus possible over the case of non-correlated data from individual sensors.

Sensor systems and/or local data communication devices 10 designed to monitor behavior which use a dial up modem, an internet modem or another communication device to transmit data can, for example, be tracked and linked to a specific person based upon a pre-assigned identification code. While such a code identifies the modem or communication device, it does not prevent the device from mistakenly being moved from one location to another. Data transmitted via such a modem or other communication device could be assigned errantly to one person when it actually belongs to another. Because healthcare providers, in the normal course of business, typically move monitoring devices from one person to another, the possibility of errors and errant data transmissions exists.

In a number of embodiments, in addition to the use of a unique identifier associated with a modem or other communication device, the systems and methods hereof incorporate the collection of phone number, IP address etc. from which a modem or other communication device is transmitting data. This information can, for example, be collected in software associated with the device and is linked to an existing person within a database. In the event that a matching phone number, IP address and/or other indication of origin cannot be identified and paired with an existing COM device serial number, the data can, for example, be stored in a staging status until a time when phone number, IP address (for example, a static IP address) etc. can be linked to an existing person. Such identifying data can, for example, reduce errors and reduce or eliminate the potential for errors in data transmission between healthcare providers or caregivers

The foregoing description and accompanying drawings set forth the preferred embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A sensor system to monitor water usage in a conduit system, comprising: at least one acoustic sensor adapted to be placed in operative connection with the conduit system, a power supply, a processor system in communicative connection with the acoustic sensor, and a communication system in communicative connection with the processor system, the sensor system being adapted to determine from output from the acoustic sensor at least start of flow and cessation of flow in the conduit system.

2. The sensor system of claim 1 wherein the sensor system determines a time associated with the start of flow, a time associated with the cessation of flow and an associated duration of flow.

3. The sensor system of claim 2 wherein the sensor system further measures ambient acoustic signals.

4. The sensor system of claim 3 wherein the acoustic sensor is a multichannel acoustic sensor, wherein one channel is adapted to measure acoustic signals from the conduit system and another channel is adapted to measure ambient acoustic signals.

5. The sensor system of claim 1 wherein the sensor system is adapted to analyze output from the acoustic sensor to determine if an acoustic signal is associated flow through the conduit system.

6. The sensor system of claim 3 wherein the sensor system is adapted to analyze an acoustic signal from the acoustic sensor to determine if the acoustic signal is associated flow through the conduit system.

7. The sensor system of claim 6 wherein the sensor system is adapted to analyze at least one of amplitude, frequency, periodicity, timing, a time-domain signature, or a frequency domain signature to determine if the acoustic signal is associated flow through the conduit system.

8. The sensor system of claim 5 wherein the sensor system is adapted to analyze output from the acoustic sensor to determine an associated cause of flow.

9. The sensor system of claim 6 wherein the sensor system is adapted to analyze output from the acoustic sensor to determine an associated cause of flow.

10. The sensor system of claim 9 the sensor system is adapted to analyze at least one of amplitude, frequency, periodicity, timing, a time-domain signature, or a frequency domain signature to determine an associated cause of flow.

11. The sensor system of claim 1 wherein the power supply comprises at least one battery, the acoustic sensor is powered to monitor acoustic signals from the conduit system continuously, and at least one other component of the sensor system is powered off until a predetermined condition is met.

12. The sensor system of claim 11 further comprising circuitry in connection with the acoustic sensor to determine if the predetermined condition is met.

13. The sensor system of claim 1 wherein the power supply comprises at least one battery, the acoustic sensor is powered to monitor acoustic signals from the conduit system continuously, and at least one other component of the sensor system is powered off until output from the acoustic sensor is determined to be associated with flow.

14. The sensor system of claim 13 further comprising circuitry in connection with the acoustic sensor to determine if output from the acoustic sensor is associated with flow.

15. The sensor system of claim 14 wherein the circuitry comprises a bandpass filter.

16. The sensor system of claim 14 wherein the processor system is powered off until output from the acoustic sensor is determined to be associated with flow.

17. The sensor system of claim 16 wherein the processor system is adapted to power off after being powered on when output from the acoustic sensor is determined to be associated with flow.

18. The sensor system of claim 2 wherein the communication system comprises a wireless transceiver.

19. The sensor system of claim 18 wherein sensor system is adapted to transmit data via the communication system at scheduled intervals of time.

20. The sensor system of claim 19 wherein the sensor system is adapted to determine if a predetermined threshold condition is met and to transmit data of the threshold condition prior to a next scheduled time for data transmission.

21. The sensor system of claim 19 wherein the threshold condition is a predefined duration of flow in the conduit system.

22. The sensor system of claim 1 wherein the output from the acoustic sensor arises from flow at any point in the conduit system mechanically linked to the position at which the sensor placed in operative connection with the conduit system.

23. A system for monitoring wellness of a person, comprising:
a local system in the vicinity of the person comprising:
a plurality of sensor systems, each of the plurality of sensor systems being associated with at least one monitored system to monitor changes in state of the monitored systems caused by activity or lack of activity of the person, at least one of the plurality of sensor systems being a water usage sensor system comprising an acoustic sensor adapted to be placed in operative connection with a conduit system, a processor system in communicative connection with the acoustic sensor, the water usage sensor system being adapted to determine at least a start of flow and an end of flow in the conduit system, and a communication in communicative connection with the processor system; and
a local data communication device in communicative connection with each of the plurality of sensor system to receive data from each of the plurality of sensor systems.

24. The system of claim 23 further comprising a remote system in communication with the local data communication device, the remote system comprising a processing system to process data from the plurality of sensor system based upon predetermined rules.

25. The system of claim 24 wherein the local data communication device is programmed to transmit data to the remote system in batches separated by intervals of time, the data transmitted to the remote system comprising information on state history of the monitored systems since a previous data transmission to the remote system.

26. A system for monitoring wellness of a person, comprising: a sensor system to monitor water usage in a conduit system comprising at least one acoustic sensor adapted to be placed in operative connection with the conduit system, a power supply, a processor system in communicative connection with the acoustic sensor, and a communication system in communicative connection with the processor system, the sensor system being adapted to determine from output from the acoustic sensor at least start of flow and cessation of flow in the conduit system.

27. A method of sensing water usage, comprising: providing at least one acoustic sensor in operative connection with a conduit system, providing a processor system in communicative connection with the acoustic sensor, and determining from output from the acoustic sensor, at least start of flow and cessation of flow in the conduit system.

28. The method of claim 27 further comprising associating water usage with wellness of a person.

29. The method of claim 27 further comprising associating water usage with unauthorized presence within a space.

30. The method of claim 27 further comprising associating water usage with a security breach.

31. The method of claim 27 further comprising associating water usage with a fault.

32. The method of claim 31 wherein the fault is a leak, unusual water usage or improper refilling of a commode.

33. The method of claim 27 further comprising analyzing at least one of amplitude, frequency, periodicity, timing, a time-domain signature, or a frequency domain signature to determine an associated cause of flow.
